(19) United States
(12) Patent Application Publication
(10) Pub. No.: US 2014/0164640 A1
(43) Pub. Date: Jun. 12, 2014

(54) SMALL PACKET PRIORITY CONGESTION CONTROL FOR DATA CENTER TRAFFIC

(71) Applicant: THE HONG KONG UNIVERSITY OF SCIENCE AND TECHNOLOGY, Kowloon (HK)

(72) Inventors: Lisha YE, Jiangsu Province (CN); Mounir HAMDI, Kowloon (HK)

(21) Appl. No.: 13/851,895

(22) Filed: Mar. 27, 2013

Related U.S. Application Data
(60) Provisional application No. 61/735,880, filed on Dec. 11, 2012.

(51) Int. Cl. H04L 12/801

(52) U.S. Cl. CPC H04L 47/12
USPC 709/235

(57) ABSTRACT

Network congestion management techniques are applied in a communication network. Network characteristics and target thresholds can be determined. A transmission mode can be determined. Further, a sending rate can be determined based on the transmission mode and network characteristics. In one aspect, network characteristics at a recent time can be determined to alter sending rates in a network to manage network congestion.

This application claims priority to U.S. Provisional Patent Application No. 61/735,880, filed on Dec. 11, 2012, entitled “SMALL PACKET GO FIRST: A UDP WITH SMALL PACKET PRIORITY FOR DATA CENTER NETWORKS.” The entirety of the aforementioned application is incorporated by reference herein.

### TECHNICAL FIELD

This disclosure relates generally to data centers and data base traffic protocols in connection with a communication network system, e.g., the management of data transmissions in a communication network system.

### BACKGROUND

With rapid growth in information technology, requirements for data storage and transfer are becoming more important. Generally, information technology services use networks that utilize Transmission Control Protocol (TCP) to communicate. TCP is a communications protocol for a transport layer in an Open Systems Interconnection (OSI). An application layer sends service requests to the transport layer and the transportation layer sends service requests with header information to a network layer.

TCP partitions data into packets prior to transmission. Packeting data allows for the transmission of large amounts of data. TCP also transmits sequencing data with packets. This facilitates reassembly upon receipt and retransmission of lost packets, at the cost of increased latency and network load.

User Datagram Protocol (UDP) is an alternative protocol for the transport layer in the OSI model. Generally, UDP is utilized in applications where error checking and correction is either not necessary or not performed in the application (as opposed to at the transportation layer). Applications often utilized UDP when time is more critical than error checking (e.g., real-time online games, streaming media, and Voice over IP). UDP transmits packets or datagrams without sequencing data without handshake dialogue. Thus, a client and server do not need to establish a connection prior to transmission in a UDP system. Since UDP does not utilize error checking for datagrams, datagrams can be lost or delivered out of order. However, UDP transmissions require lower network overhead and have reduced latency in comparison to TCP transmissions.

The above-described conventional techniques are merely intended to provide an overview of some issues associated with current technology, and are not intended to be exhaustive. Other problems with the state of the art may become further apparent upon review of the following detailed description of the various non-limiting embodiments.

### SUMMARY

The following presents a simplified summary to provide a basic understanding of some aspects described herein. This summary is not an extensive overview of the disclosed subject matter. It is not intended to identify key or critical elements of the disclosed subject matter, or delineate the scope of the subject disclosure. Its sole purpose is to present some concepts of the disclosed subject matter in a simplified form as a prelude to the more detailed description presented later.

Transmissions of data between network components utilizing traffic and congestion management techniques are described. In one aspect, a device can dynamically manage network congestion based on a determined level of network traffic. For example, a device can determine a level of bandwidth used compared to a total level of bandwidth available, a number of not serviced data packets, and the like. The device can determine a mode of operation based on the level of network congestion. In another aspect, a network can utilize substantially current network characteristics, such as a real queue depth, to determine and select a level of congestion.

A device can manage a rate of transmission based on a transmission mode. For example, a sender can operate in a standard mode to send data packets as frequently as the sender can operate. In another aspect, the sender can operate in a congested mode and constrict sending of data packets to a threshold rate.

A network can apply different transmission management to different senders in the network. In one aspect, various systems and methods disclosed herein can guarantee fairness and convergence during periods of a threshold level of congestion (e.g., bursts of network traffic).

Data transmissions can be managed by prioritizing packeted communications. Priority can be based on packet sizes. In an aspect, a virtual queue can monitor network conditions and determine priority based on the network conditions and packet sizes of incoming packets. Packet priority can be utilized to determine a packet to be marked and/or dropped.

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a high level functional block diagram of a layered network in accordance with various embodiments.

FIG. 2 illustrates a functional illustration of a layered network capable of managing congestion in accordance with various embodiments.

FIG. 3 presents a high level block diagram of a system including a receiver, a sender, and a network component, in accordance with various embodiments.

FIG. 4 illustrates a high level block diagram of packet structures including a data packet and a control packet in accordance with an embodiment.

FIG. 5 illustrates a high level schematic diagram of a SP-DCUDP component, including a priority component, in accordance with various embodiments.

FIG. 6 illustrates a high level schematic diagram of an edge switch component, in accordance with various embodiments.

FIG. 7 illustrates a high level block diagram of a communication system that can manage network traffic in accordance with various embodiments.

FIG. 8 illustrates a flow diagram of facilitating dynamic congestion control in a network in accordance with various embodiments.

FIG. 9 illustrates a flow diagram of determining a transmission mode in a network in accordance with various embodiments.

FIG. 10 illustrates a flow diagram of facilitating dynamic network congestion control including managing a congestion mode in accordance with various embodiments.

FIG. 11 illustrates a flow diagram of a method for altering transmission parameters and managing a transmission mode in a network in accordance with an embodiment.

FIG. 12 illustrates a flow diagram of facilitating dynamic congestion control with small packet priority in a network in accordance with various embodiments.

FIG. 13 illustrates a flow diagram of facilitating dynamic congestion control with small packet priority for dropping packets in a network in accordance with various embodiments.

FIG. 14 illustrates a flow diagram of facilitating dynamic congestion control with small packet priority for dropping packets including comparing packet sizes in a network in accordance with various embodiments.

FIG. 15 illustrates a flow diagram of facilitating dynamic congestion control with small packet priority to manage queues in a network in accordance with various embodiments.

FIG. 16 illustrates an example block diagram of a computer operable to execute various aspects of this disclosure in accordance with the embodiments disclosed herein.

### DETAILED DESCRIPTION

In the following description, numerous specific details are set forth to provide a thorough understanding of the embodiments. It is noted, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

Moreover, the word “exemplary” where used herein to means serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Embodiments of the invention may be used in a variety of applications. Some embodiments of the invention may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, a wireless communication station, a wireless communication device, a wireless access point (AP), a modem, a network, a wireless network, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or long term evolution (LTE) of the above standards, units and/or devices which are part of the above networks, one way and/or two-way radio communication systems, cellular radio-telephone communication systems, a cellular telephone, a wireless telephone, a personal communication systems (PCS) device, a PDA device which incorporates a wireless communication device, a multiple input multiple output (MIMO) transceiver or device, a single input multiple output (SIMO) transceiver or device, a multiple input single output (MISO) transceiver or device, or the like.

It is noted that various embodiments can be used in conjunction with one or more types of wireless or wired communication signals and/or systems, for example, radio frequency (RF), infra red (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, multi-carrier modulation (MDM), discrete multi-tone (DMT), Bluetooth®, ZigBee™, or the like. Embodiments of the invention may be used in various other devices, systems and/or networks.

While portions of this disclosure, for demonstrative purposes, refer to wired and/or wired communication systems or methods, embodiments of the invention are not limited in this regard. As an example, one or more wired communication systems, can utilize one or more wireless communication components, one or more wireless communication methods or protocols, or the like.

The term “UDP” as used herein can include, a User Datagram Protocol which may be used in addition to or as an alternative to TCP/IP, for example. Further, UDP systems and methods can include wireless or wired UDP communication, UDP like systems and or methods, UDP communication over a communication network (e.g., the Internet, Ethernet, iWarp, network adaptors with OS bypass capabilities), communications using kernel UDP socket(s) (e.g., in addition to or as an alternative of using kernel TCP/IP sockets), and/or other types of communication. In some embodiments, for example, UDP communication can be used to facilitate, streaming media and applications that are streaming data (e.g., audio, video, text, other streaming media applications, video games, voice over IP (VoIP), video-conferencing, File Transfer Protocol (FTP)), applications in which dropped or erroneous packets are not re-transmitted, applications utilizing transmission of datagrams, packets, and/or time-sensitive datagrams. Further, UDP communications can utilize applications that do not require confirming receipt of packets/datagrams, state-less communication applications, broadcast applications or communications, multicast applications or communications, web-cast applications or communications, non-unicast applications or communications, domain name server (DNS) applications, or the like. In some embodiments, UDP may be used in conjunction with other forms of delivery of information, for example, TCP and TCP like systems and/or methods.

Although some portions of the discussion herein may relate, for demonstrative purposes, to a fast or high-speed interconnect infrastructure, to a fast or high-speed interconnect component or adapter with OS bypass capabilities, to a fast or high-speed interconnect card or Network Interface Card (NIC) with OS bypass capabilities, or to a to a fast or high-speed interconnect infrastructure or fabric, embodiments of the invention are not limited in this regard, and may be used in conjunction with other infrastructures, fabrics, components, adapters, host channel adapters, cards or NICs, which may or may not necessarily be fast or high-speed or with OS bypass capabilities. For example, some embodiments of the invention may be utilized in conjunction with InfiniBand (IB) infrastructures, fabrics, components, adapters, host channel adapters, cards or NICs; with Ethernet infrastructures, fabrics, components, adapters, host channel adapters, cards or NICs; with gigabit Ethernet (GEth) infrastructures, fabrics, components, adapters, host channel adapters, cards or NICs; with infrastructures, fabrics, components, adapters, host channel adapters, cards or NICs that have OS with infrastructures, fabrics, components, adapters, host channel adapters, cards or NICs that allow a user mode application to directly access such hardware and bypassing a call to the operating system (namely, with OS bypass capabilities); with infrastructures, fabrics, components, adapters, host channel adapters, cards or NICs; with infrastructures, fabrics, components, adapters, host channel adapters, cards or NICs that are connectionless and/or stateless; and/or other suitable hardware.

The systems and methods described herein, generally relate to transmissions traffic control in data centers. In one aspect, a small packet go first data center user datagram protocol (SP-DCUDP) can provide congestion control using an Explicit Congestion Notification (ECN) component. For example, SP-DCUDP can actively monitor congestion based on network characteristics. ECN can be utilized to trigger components to switch transmission modes or maintain a transmission mode when a congestion level is compared to a threshold level.

The various systems, methods, and apparatus described herein employ Explicit Congestion Notification (ECN) in a UDP based protocol for data centers to manage network throughput and congestion. In various examples, SP-DCUDP systems can support a packet loss-retransmission scheme without requiring modification of UDP or UDP-like architecture.

Various other embodiments provide for management of traffic across a network through network congestion control schemes. For example, a device is described having a network monitor component that monitors bandwidth in a network. The device can determine a level of congestion in a network. In another example, a device is described having a congestion control component that can utilize the congestion level to select a mode of operation, such as a standard mode (UDP mode) or a congestion mode. In one aspect, the mode of operation can alter a rate of transmission (e.g., rate packets are sent).

Various other embodiments provide for management of traffic across a network through prioritized network congestion control schemes. For example, a device is described having am edge switch component that monitors packets of information. The edge switch component can set a priority for packets and determine to drop or mark a packet with an ECN flag. In one aspect, the edge switch component can manage a queue length for a queue storing packets to be processed.

The terms “standard mode,” “UDP mode,” “normal mode,” “non-congested mode,” and the like are used interchangeably, unless contexts suggests otherwise, to refer to a transmission mode for non-congested networks.

In another aspect, the terms “congested,” “congestion,” “network congestion,” and the like are used interchangeably unless context suggests otherwise. The terms can refer to a one or more characteristics, metrics, and/or properties of a network meeting or exceeding a threshold level(s), unless context suggests otherwise. The threshold level(s) being determined as a maximum and/or minimum level(s) of the one or more characteristics, metrics, and/or properties of a network needed to satisfy a condition of a congested network.

The term real queue can refer to a device that stores a series of packets or other units of data (e.g. frames, bytes, etc.; hereafter, generally referred to as “packets”) for transmission, unless context suggests otherwise. A real queue may store packets in a First-In-First-Out (FIFO) fashion, may reorder the packets, may release packets to a processing unit, and/or transmit packets.

The term virtual queue may include a queue that is simulated by an apparatus, computer, or processing device (e.g. a network processor, etc.) and may not physically exist as a distinct device, such as a real queue. For example, in various embodiments, a virtual queue may simply include a counter or sets of counters. In various embodiments, a virtual queue may not actually contain or hold data or packets but may simulate features or the state (e.g. capacity, percentage used, etc.) of a queue if it did hold or contain such packets. However it is noted, that various implementations of the virtual queue may include a computer model of an actual physical queue and/or an actual physical queue. Virtual queues, as referred to herein, can comprise all functionality of a real queue with an adaptive capacity update, unless context suggests otherwise.

In an example, a virtual queue can be a simulated queue in a port (e.g., switch) with an adaptive length, and/or an adaptive speed. In an aspect, a virtual queue can work like a counter that calculates queuing situations, such as queue depths, expected depths, queue trends, and the like. In an aspect, a virtual queue can have a virtual link, having a speed that can be disparate from a speed of a link of a real queue.

In another aspect, a wireless communication method is derived comprising, generating control information and transmitting the control information through transmissions. Sending rates pertaining to transmissions can be based on Round Trip Delay Time (RTT) parameters. In one aspect, sending rates are determined to achieve fairness during periods above a determined network congestion level.

In yet another aspect, a device can include means for generating control information and means for transmitting the control information. Another device can include means for determining a level of network congestion, means for receiving data, means for sending data, means for altering a rate of transmission, means for prioritizing packets, and means managing packet data.

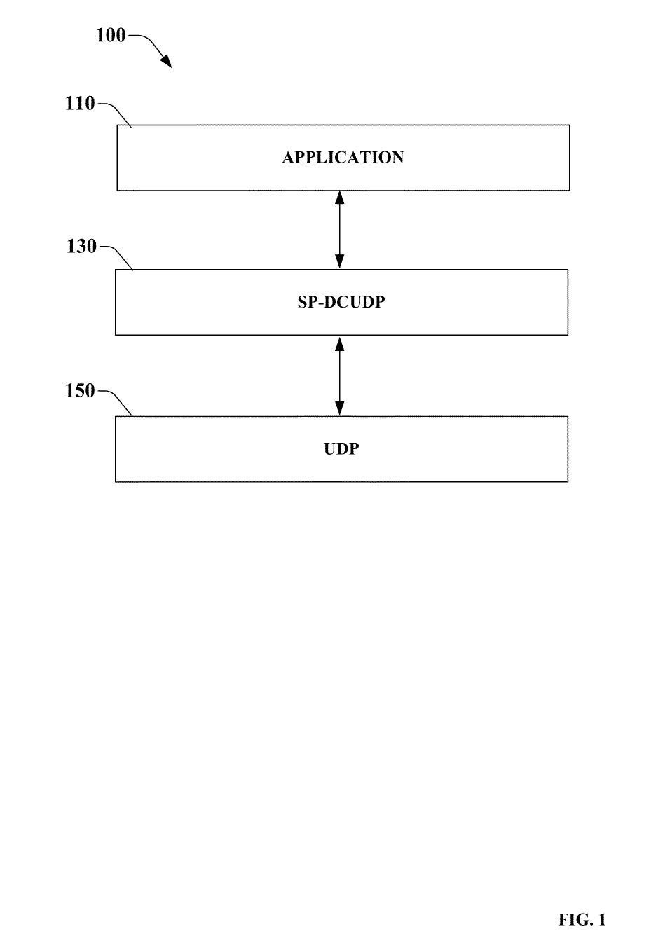

FIG. 1 illustrates a SP-DCUDP system 100 in accordance with various embodiments. Aspects of the systems, apparatuses or processes explained herein can constitute machine-executable components embodied within machine(s), e.g., embodied in one or more computer readable mediums (or media) associated with one or more machines. Such component, when executed by the one or more machines, e.g., computer(s), computing device(s), virtual machine(s), etc., can cause the machine(s) to perform the operations described.

In an aspect, system 100 can be a multi-layered communication system with a SP-DCUDP lawyer for transferring data over a network (e.g., Internet, intranet, etc.). The system 100 illustrated in FIG. 1 can include an application layer 110, a SP-SP-DCUDP layer 130, and a UDP layer 150. The application layer 110 can pass data through the SP-SP-DCUDP layer 130. The SP-SP-DCUDP layer 130 can use the UDP layer 150 for sending and receiving data. In another aspect, the SP-SP-DCUDP layer 130 and the UDP layer 150 can be part of application layer 110. For example, a seven layer model can comprise the following layers: application, presentation, session, transport, network, data link, and physical. The SP-SP-DCUDP layer 130 and the UDP layer 150 can be comprised in the application layer, in their one distinct layer, or comprised in other layers. It is noted that, SP-DCUDP can utilize a DCUDP layer in various embodiments without modification to the DCUDP layer. Accordingly, a system employing a SP-DCUDP layer can be utilized to perform DCUDP functions.

The application layer 110 can provide a user interface to a communication system. In an aspect, a user and the application layer 110 can both communicate with software applications. The application layer 110 can identify communication partners, determine resource availability, and synchronize communication. In an aspect, when identifying communication partners, the application layer 110 determines the identity and availability of communication partners for an application having data to transmit. When determining resource availability, the application layer 110 can decide whether sufficient network recourses or the requested communication exists.

In one implementation, the application layer 110 passes data through the SP-SP-DCUDP layer 130 and the UDP layer 150. The SP-SP-DCUDP layer 130 can include SP-DCUDP applications or components for executing SP-DCUDP functions as described herein. Likewise, the UDP layer 150 can comprise UDP applications, SP-DCUDP applications, or components for executing UDP and/or SP-DCUDP functions as described herein, such as creating UDP sockets (e.g., adding a UDP membership to a socket).

In one aspect, the UDP layer 150 can interact with sockets, protocol handlers, an application programming interface (API), layers of a UDP/IP stack, and/or network communication components.

In embodiments, the UDP layer 150 can utilize multiple network interfaces, for example, the InfiniBand HCA, and the GEth hardware, and/or other ports or cards. For example, the UDP layer 150 can directly handle UDP communications associated with multiple network interfaces, e.g., serially, in parallel, substantially simultaneously, or the like.

The SP-DCUDP layer 130 can comprise a connection-oriented duplex such that each DCUDP entity has at least a pair of senders and receivers. In an embodiment, data flows can be sent from the sender to the receiver, and control flows can be communicated between receivers and/or between senders and receivers. The DCUDP layer can use a handshake packet to set up a connection. In another aspect, the SP-DCUDP layer 130 can send data messages, or data grouped into packets. The packets can be sent from one device in a network to another device in the network. In an aspect, the SP-DCUDP layer 130 can communicate without setting up a special transmission channel or data path.

In one embodiment, the SP-DCUDP layer 130 can group packets into one or more types. The packets can be used to facilitate reliable transmissions and partial reliable messaging. In one example, the packets can be grouped into data packets and control packets. Each packet type can comprise a number of commands or sub-packets. In an aspect, packet types can be predefined by a library. In an example, control packets can include ACK packets, ACK2 packets, NAK packets, Hand-shake packets, keep-alive packets, shutdown packets, and the like.

The SP-DCUDP layer 130 can periodically send ACK packets from a receiver side. A sender side can respond with an ACK2 packet for RTT calculation. In an aspect, the SP-DCUDP layer 130 can use RTT calculations to control congestion across a network. In another aspect, the NAK packet is sent indicating a lost signal. For example, a receiver can monitor a sequence of numbers in received packets. If the receiver determines the sequence is interrupted or incomplete, the receiver can send a NAK packet. The NAK packet can include data indicative of control information to notify the senders of which packets were lost and which packets require re-transmission.

In one example, the system 100 can be implemented on top of and/or in conjunction with UDP (or UDP-like) systems without adding hardware components or structural alterations. In one aspect, SP-DCUDP can add congestion control and reliability control to UDP legacy systems and or methods, while utilizing connection oriented communication.

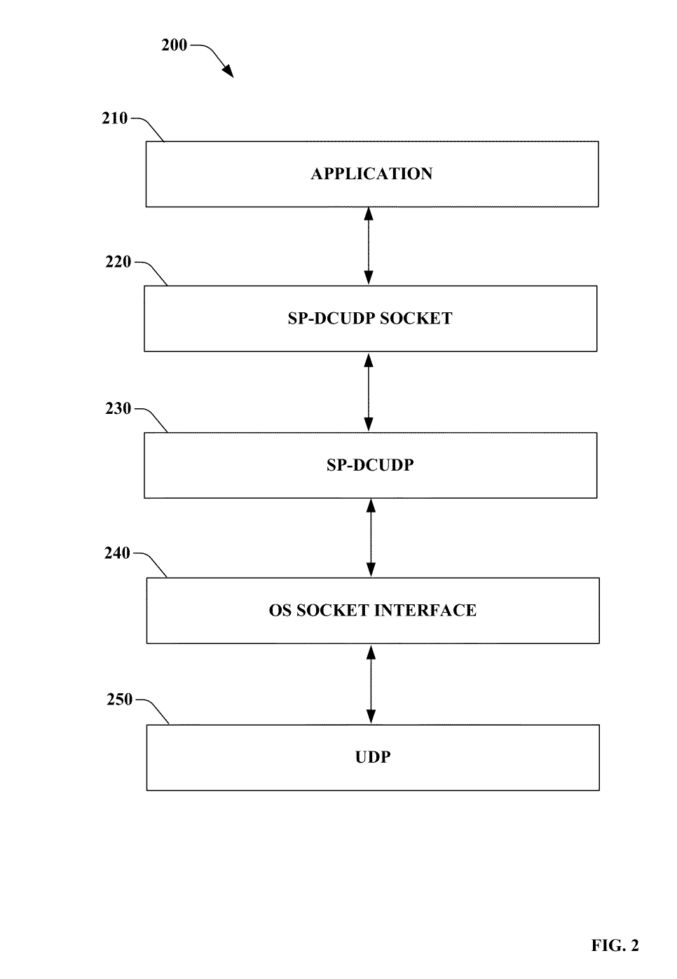

FIG. 2 illustrates a SP-DCUDP system 200 operable in various embodiments of communications systems presented herein. System 200 depicts a layered communication network using socket communication provided by an operating system. As seen in FIG. 2, an application layer 210 interfaces with a SP-DCUDP socket 220. The SP-DCUDP socket 220 establishes a connection with a SP-DCUDP layer (core) 230. Between the SP-DCUDP layer 230 and a UDP layer 250 is an operating system (OS) socket interface 240. In an aspect, the system 200 can utilize SP-DCUDP functions as described herein. It is noted that the system 200 can employ various DCUDP aspects (e.g., SP-DCUDP layer 230, and SP-DCUDP socket 220) to perform SP-DCUDP functions.

In system 200, the SP-DCUDP socket 220 can establish host-to-host communications. As an example, an application binds a socket to its endpoint of data transmission, which is a combination of an IP address and a service port. A port is a software structure that is identified by the port number, a 16 bit integer value, allowing for port numbers between 0 and 65535. In an embodiment, port 0 is reserved, but is a permissible source port value if the sending process does not expect messages in response.

In another aspect, the SP-DCUDP layer 230, the application layer 210, and the UDP layer 250 can set up socket connections. As an example, a sender device and a receiver device can each implement aspects of system 200, to connect with each other. It is noted that one or more senders can connect with one or more receivers. Packets can be sent from a sender to a receiver (or receiver to sender) through socketed connections utilizing the SP-DCUDP socket 220, for example.

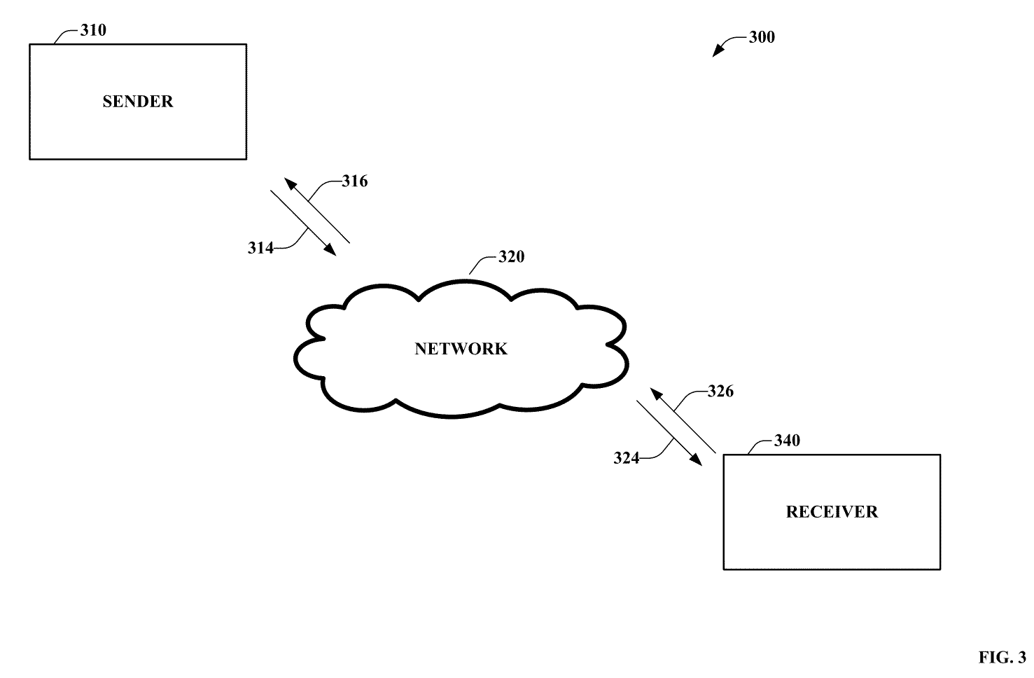

Referring now to FIG. 3, presented is a high level block diagram of a SP-DCUDP system 300 configured to employ a SP-DCUDP functionality. As seen in FIG. 3, system 300 includes a sender 310, a network 320, and a receiver 340. It is noted that the sender 310 and the receiver 340 can be various types of computing devices, such as personal computers, tablet computers, smart phones, set top boxes, desktop computers, laptops, gaming systems, servers, data centers, and the like. The sender 310 and the receiver 340 can connect to the network 320 (e.g., wireless and/or wired connection).

In an embodiment, the network 320 can comprise one or more of the Internet, an intranet, a cellular network, a home network, a person area network, etc., through an ISP, cellular, or broadband cable provider, and the like. The network 320 can comprise one or more network components, data servers, connection nodes, and the like. In another aspect, the sender 310 and the receiver 340 can be considered as part of the network 320.

In one aspect, the sender 310 and the receiver 340 can establish a connection through the network 320. It is noted that a plurality of other devices can establish a connection through the network 320. However, only the sender 310 and the receiver 340 are shown in FIG. 3 for brevity.

The system 300, can employ congestion control methods to manage network congestion. Congestion control includes a number of different implementations that may differ in which transmission parameters are adjusted and/or in how these parameters are estimated. In contrast, TCP and variations thereof (e.g., UDT), utilize an algorithm called “slow start.” The slow start algorithm, utilizes a buffer size at a sending component set to an initial value. A TCP sending component sends a message and will wait for an acknowledgement by a TCP receiving component. After receiving the acknowledgement, the sending component transmits additional data and receives corresponding acknowledgements. Congestion control methods utilizing the slow start algorithm, or variations thereof, fail to handle burstiness in times when a switch queue depth exceeds a threshold. In an aspect, burstiness can refer to uneven periods of traffic, or spurts of network traffic. As an example, average traffic usage can be measured over a period. During the period there may be spikes in traffic and periods of relative low traffic, as opposed to steady increases/decreases, or constant in network utilization (e.g., traffic). Thus, in a bursty network, an average utilized bandwidth can be manageable but periods of burstiness can cause decreased quality of service or user experience.

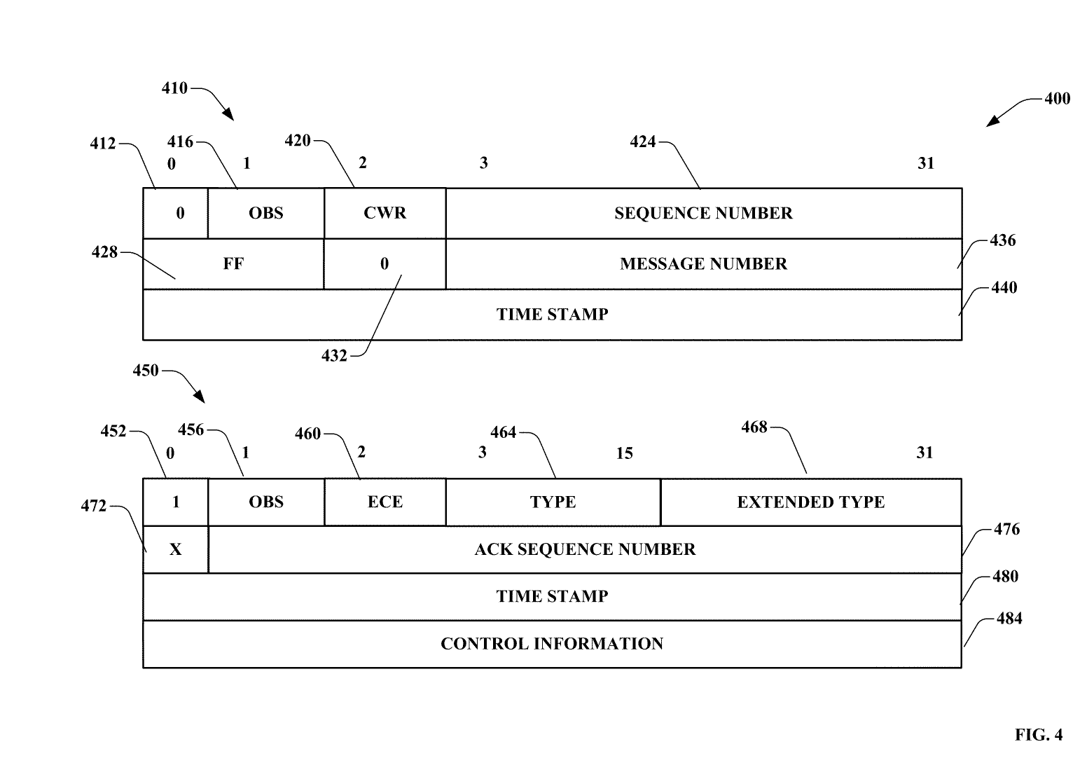

Turning to FIG. 4, with reference to FIG. 3, there illustrated is a high level diagram of a communication packeting system 400 in accordance with various embodiments of DCUDP systems presented herein. A data packet 410 and a control packet 450 are illustrated as exemplary packets. Each packet can comprise any number of bits, 0-31 (total of 32 bits) as illustrated in FIG. 4.

In an aspect, a SP-DCUDP system, such as the system 300, can utilize a sender (e.g., the sender 310) to determine a packet to send. In one embodiment, the sender 310 sets a first bit (or flag bit) 412 of a packet based on a packet type. For example, the first bit 412 of data packet 410 is set to “0” correspond to a data packet type. The first bit 452 of control packet 450 is set to “1” designating the packet as a control packet type. It is noted that various other bits or combinations of bits can specify a packet type. However, for simplicity of explanation, the leading bit (position zero) is utilized herein to distinguish packet types.

The data packet 410 includes an observation bit (OBS bit) 416 to indicate a mode of transmission. In one embodiment, a network component (e.g., the sender 310 or the receiver 340) can set the OBS bit 416. For example, the OBS bit 416 can be set to “1” during a congestion mode and set to “0” during a standard mode. In an aspect, setting the OBS bit 416 to “1” can trigger senders to enter a congestion mode of congestion control, and/or to stay in a congestion mode. Likewise, control packer 450 can include an OBS bit 456 which is similar to OBS bit 416.

In another aspect, the data packet 410 can include a congestion window reduce (CWR) bit 420, that indicates a congestion window is reduced, such as for a packet drop. In one example, if a receiver receives a data packet with a congestion experienced (CE) code point set on, then the receiver sends an ACK with ECE bit set. In an embodiment, the CE code point can be sent at an IP layer, based on a level of congestion. The control packet 450 includes an ECN-echo (ECE) bit 460. The ECE bit 460 can determine whether a sender should slow down transmissions and can notify other components that an ECE bit 460, which is set on, has been received.

In another aspect, the network 320 can comprise various network components, such as an edge switch component. The network 320 can employ the network components to manage transmissions. In an example, network components can store received transmissions 314, such as data packets sent by the sender 310, in one or more queues. In various embodiments, the network 320 can manage data packets according to a priority scheme. For example, the network 320 can monitor various parameters, such as average data packet size, queue lengths, and the like. The network 320 can set the ECE bit 460 of various data packets based on a comparison between a data packet size and the average data packet size, various thresholds, and queue lengths, as described herein. In one aspect, the network 320 can forgo setting the ECE bit 460 of data packets and drop data packets directly. It is noted that dropped data packets can be re-transmitted by the sender 310.

The data packet 410 can include a sequence number 424 using the remaining bits after the flag bit 412, the OBS bit 416, and the CWR bit 420. The DCUDP system 300 uses packet based sequencing where the sequence number is increased by one for each sent data packet in the order of packet sending. The sequence number is reset (or wrapped) after it is increased to the maximum number (2²⁹−1).

The next 32-bit field in the data packet 410 is for a message. A first two bits, (“FF” bits) 428, flags the position of the packet is a message. For example, “10” is the first packet, “01” is the last one, “11” is the only packet, and “00” is any packets in the middle. It is noted that other position flagging conventions can be implement. A third bit 432 “O” means if the message should be delivered in order (1) or not (0). A message to be delivered in order requires that all previous messages must be either delivered or dropped. The remaining 29 bits represent a message number 436. The message number 436 is similar to the sequence number 424, but is independent. In one aspect, a DCUDP message may contain multiple UDP packets.

The data packet 410 can also include a 32-bit time stamp 440. The time stamp 440 can indicate when the data packet 410 was sent and a destination socket ID. In one aspect, the time stamp 440 can be a relative value starting from the time when the connection is set up. In another aspect, the time stamp 440 can be based on a time of a central server, a local device, and the like. It is noted that, DCUDP may not require the time stamp 440 for native control algorithms and the time stamp 440 can be included for user defined control algorithms. It is also noted that the data packet 410 can include additional fields, such as destination ID (for UDP multiplexers), UDP socket ID, and the like.

In another aspect, the control packet 450 can include a flag bit 452 similar to the flag bit 412. The control packet 450 can also include type bits 464 the contents of following fields depend on the packet type as determined by the type bits 464. In another aspect, extended type bits 468 can provide more information on the type of control packet. A reserved bit (X) 472 is reserved for use in particular types of the control packet 450. In another aspect, the control packet 450 can use ACK packet sequencing to assignee a unique increasing ACK sequence number 476. The ACK sequence number 476 can be independent of a data packet sequence number (e.g., the sequence number 424).

In another aspect, the control packet 450 can also include a time stamp 480. The time stamp 480 can be a relative value starting from the time when a connection is set up, and/or based on a central clock, a local clock, and the like. Additionally or alternatively, the control packet 450 can include control information 484 (e.g., information indicating which packets are lost, which packets need retransmission, etc.). The control information can facilitate operations of DCUDP communications, such as reliable packet deliver, congestion management, and the like.

Turning back to FIG. 3, the SP-DCUDP system can facilitate one or more different connection setup methods. In one example, SP-DCUDP can support a client/server set up mode and/or a rendezvous set up mode.

In one example, the sender 310 and the receiver 340 can operate in the rendezvous mode. In the rendezvous mode, the sender 310 and the receiver 340 both send a handshake request (e.g., a control packet with a handshake type). The handshake packet can comprise information to setup a connection between the sender 310 and the receiver 340, such as SP-DCUDP version, socket type, initial sequence number, packet size, flow window size, connection type, socket IDs, cookies, IP addresses, and the like. The rendezvous connection setup is typically applied when both peers (e.g., sender and receiver) are behind firewalls, and to provide better security and usability when a listening device is not desirable.

In another example, the sender 310 and the receiver 340 can operate in a client/server mode. In an aspect, the sender 310 and/or the receiver 340 can operate as the server or listener. For clarity, the receiver 340 is assumed to act as the server and the sender 310 is assumed as the client herein. However, it is notes, that the sender 310 can act as the server and the receiver 340 can act as the client.

While in client/server mode, the sender 310 can send a handshake packet, e.g., data 314 sent through network 320, to the receiver 340. The sender 310 can continue sending handshake packets once at an interval until it receives a response handshake, sent from the receiver 340 as a responsive packet 326 through the network 320 and to the sender 310 as data 316, or when a timeout timer expires.

Continuing with the client/server mode setup, when the receiver 340 first receives a connection request from the sender 310, the receiver 340 can create a cookie value based on the sender 310's address and a secret key. The receiver 340 can transmit the cookie value to the sender 310. The sender 310 can send back the same cookie to the receiver 340. In another aspect, the receiver 340 can compare a received handshake packet to determine if a cookie value, packet size, maximum window size, and other data is correct based on its own values. The receiver 340 can send result values and an initial sequence number to the sender 310 as a response handshake packet. The receiver 340 is then ready for sending/receiving data. However, the receiver 340 must send back response packets as long as it receives any further handshakes from the sender 310. In another aspect, the sender 310 can start sending/receiving data once it gets a response handshake packet from the receiver 340.

In another aspect, the SP-DCUDP system 300 can include ECN enabled congestion control management components and/or techniques. As an example, ECN techniques can be applied to increase throughput and manage communication congestion. In one embodiment, the SP-DCUDP system 300 can monitor bandwidth usage across the network 320, at the sender 310, and/or at the receiver 340. The SP-DCUDP system 300 can compare a network congestion level to a threshold. If the network congestion level is not equal to or above a threshold, then the sender 310 and the receiver 340 can transmit data as fast and often as possible, without regard to congestion management (e.g., standard mode). However, when the bandwidth usage is equal to or above the threshold level of usage, the SP-DCUDP system 300 can enter a congestion mode to control the transmissions from the sender 310 and the receiver 340. It is noted that more than two transmission modes can be utilized, as an example, the system 300 can be configured to determine a congestion level and select a transmission mode from a set of transmission modes comprising a UDP mode, a congestion mode, and a heavy congestion mode. In an aspect, the system 300 can alter sending rates for data transmission based on the respective transmission modes.

In various embodiments, the packets 410 and 450 can indicate whether a packet has been lost. For example, sequential number fields in the packets 410 and 450 can be compared to other packets. If sequential numbers are determined to be missing, then a packet can be determined to have been lost. In one example, a NAK packet type can indicate a packet loss signaling. A NAK type packet can be sent if a receiver continues to receive inconsequent sequence numbers in data packets. The NAK type packet can contain control information to notify a sender which packets are lost and which packets need retransmission.

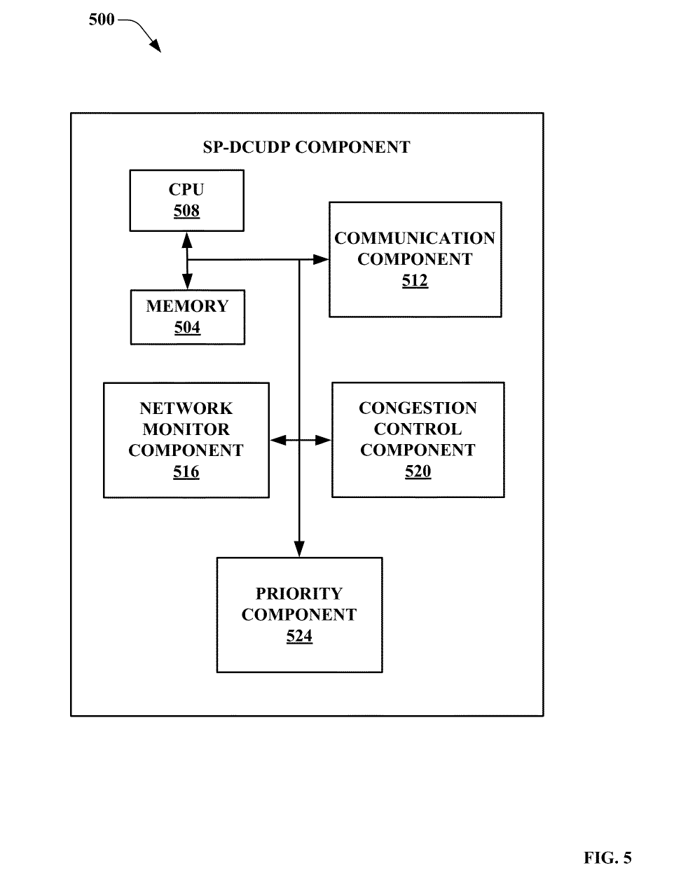

Turning to FIG. 5, presented is a high level schematic diagram of a SP-DCUDP system 500 operable in a SP-DCUDP network system described herein. The SP-DCUDP component can include a memory 504, a processor 508, a communication component 512, a network monitor component 516, a congestion control component 520, and a priority component 524. Memory 504 holds instructions for carrying out various operations of components, such as the communication component 512, the network monitor component 516, and the congestion control component 520. The processor 508 facilitates controlling and processing all onboard operations and functions of the components. Memory 504 interfaces to the processor 508 for storage of data and one or more applications of the communication component 512, the network monitor component 516, the congestion control component 520, and the priority component 524. The applications can be stored in the memory 504 and/or in a firmware, and executed by the processor 508 from either or both the memory 504 and/or the firmware (not shown). It is noted that SP-DCUDP component 500 is depicted as a single device but can comprise one or more devices coupled together or across a network. For example, aspects of the priority component 524 can comprise one or more components in a receiver, a sender, or in a network, such as an edge switch device.

In some embodiments, the SP-DCUDP component 500 can comprise one or more of a server device, a client device, a sender (e.g., the sender 310), a receiver (e.g., the receiver 340), a data center, and/or other computing device. The system 500 can be configured to employ the components in order to manage communication over a network with congestion control management, packet size based priority management, and fairness management. In particular, the system 500 is configured to monitor network traffic and bandwidth utilization of a network. Further, the system 500 can alternate between communication modes based on a triggering event. In one aspect, the system 500 monitors for a triggering event based on network traffic and bandwidth utilization of a network (e.g., resource availability, throughput, etc.).

With reference to FIG. 3, the system 500 can function as the sender 310. In a standard mode (e.g., default UDP mode), the communication component 512 sends packets over a network (e.g., the network 320). In the standard mode, the communication component 512 sends packets across a network as much as possible (e.g., subject to processing speeds, transmission speeds, etc.), similar to UDP-type systems. The communication component can receive keep alive packets from a receiver. In an implementation, the system 500 can utilize a “keep-alive” packet during a UDP mode. In one aspect, the system 500 can use limited types of control packets during the UDP mode. For example, in one implementation, the only type of control packet sent during UDP mode is a keep-alive packet. In various aspects, the keep-alive packet can prevent sudden corruption of a network connection.

In another aspect, the network monitor component 516 can set a CWR bit of a data packet (e.g., the CWR bit 420 of the data packet 410). For example, the network monitor component can determine to set a CE code point on the IP layer based on monitoring of thresholds. The thresholds can include a threshold minimum (e.g., th_min) indicating a minimum level (e.g., a packet in a data packet queue) and a threshold maximum (e.g. th_max) indicating an upper threshold level. In one aspect, the network monitor component 516 can manage one or more queues that store packets to be delivered. In another aspect, th_max and th_min can reflect dimensions of a queue.

In one aspect, the network monitor component 516 can monitor dimensions of one or more queues. Dimensions of queues can include a current depth, an average depth, a rate of depth change, and the like. In an example, the network monitor component 516 determines queue depth based on a current (e.g., real time, near-real time) depth of a queue. A current depth can reflect a depth at a given point in time, whereas an average depth can reflect a queue depth over a period of time with dissimilar start and end times. In one aspect, determining a current depth can allow the network monitor component 516 to determine when DCUDP component 500 is in a congested state. In another aspect, utilizing a current queue depth can facilitate handling of burstiness in a network and can facilitate fairness.

In one embodiment, the network monitor component 516 can set a value for th_max. The th_max can be determined to control a greedy transmission, such as a transmission using respectively more bandwidth than other transmissions. As an example, th_max can be determined as long as the following equation stands, assuming th_max is a maximum threshold for a queue size, Max_{qsize} represents a maximum switch buffer size, RTT_{idle} represents a RTT during a idle times, Interval represents an average sending interval, Delay represents an average link delay, N represents an expected maximum number of senders:

$$th\_max + N \frac{{RTT}_{idle} + th\_max * Delay}{Interval} - \frac{{RTT}_{idle} + th\_max * Delay}{Delay} \leq {Max}_{qsize}$$

The threshold th_max can be used to trigger a switch from a standard mode to a congestion mode. In another aspect, the system 500 can be configured to retain packets after a queue grows larger than th_max. It is noted that packets may be dropped on a selective basis (e.g., importance, fairness, etc.), according to a threshold, and the like.

The CWR bit can be set at an IP interface by an intermediate node in a network. Likewise, it is noted that the one or more queues can be monitored at an IP interface by intermediate nodes. Further, it is noted that an IP interface can comprise edge switches, one or more queues, servers, and the like.

In one aspect, the system 500 can send data indicating a packet is a DCUDP (e.g., ECN Capable Transport) by marking them with a CE code point. In various embodiments, the network monitor component 516 can set the CE code point instead of dropping pockets in order to signal impending congestion.

In another aspect, the network monitor component 516 can receive data triggering a switch from a standard mode to a congestions mode. As an example, the communication component 512 can receive packeted data indicating that the DCUDP device 500 should enter a congestion mode. With reference to FIG. 4, the control packet 450 can comprise data indicating a packet type of ACK as determined by the type 464 and/or extended type 468. The control packet 450 can also comprise the OBS bit 456 set to “1” to indicate entering congestions mode.

In congestion mode, the congestion control component 520 can generate control packets for the communication component 512 to send. For example, the congestion control component 520 can generate an ACK2 type packet, with an OBS bit set to “1” (e.g., on).

In another aspect, the congestion control component 520 can alter a packet sending rate (e.g., interval). The congestions control component can determine a range of rates for which packets can be sent. In one embodiment, a number of rates are determined, such as a rate at which packets are sent (Rate_{data}) and maxim rate a sender can send data (Rateₘₐₓ). It is noted that the congestion control component 520 can determine to send at least one packet per RTT, however the congestion control component 520 can be configured such that m packets are sent per y RTTs, where m and y are numbers. In one aspect, values for m and y can be selected to achieve a level of fairness. In one aspect, Rate_{data}, Rateₘₐₓ, and Interval_{data}, can be expressed as:

$${Rate}_{data} = \frac{C * {10}^{6}}{8 * PktSize} ( packets / sec )$$

$${Interval}_{data} = \frac{1}{{Rate}_{data}} ( sec )$$

$${Rate}_{max} = {Rate}_{data}$$

In congestion mode, the congestion control component 520 can manage transmission to control congestion among a network or components thereof. In one aspect, the control component 520 can react to various types of control packets while in congestion mode. In an aspect, the congestion control component 520 no longer determines Rate_{data} or Rateₘₐₓ when an ECE is received. Rather the congestion control component 520 receives ACK packets at an interval of RTT and responds accordingly. As an example, one or more data packets are received every RTT. In another aspect, responding to ACK packets can control a growth rate.

In an embodiment, the congestion control component 520 applies a rate adjustment lock. A rate adjustment lock can be reset as false each time a data packet is sent at each interval (e.g., Interval_{data}). As an example, the congestion control component 520 can apply a rate adjustment lock, (e.g., freeze command) such that transmissions are not slowed down greater than needed. It is noted that the rate adjustment lock can be applied at different intervals than Interval_{data}, such that the congestion control component 520 can manage rate adjustments according to desired intervals, based on a target adjustment rate, and the like.

In various implementations, the priority component 524 can employ small packet priority schemes to manage packets. A small packet priority scheme can give priority to packets based on respective sizes of the packets. In an aspect, a packet with higher priority is processes before a packet with lower priority. In an example, one or more packets with low priority, relative to other packets, can be marked for ECN (e.g., setting CWR bit 420 to “1”), and/or can be dropped.

As an example, a system can comprise multiple senders accessing a receiver through a network. The network can comprise an edge switch configured to store data packets sent from the senders to a receiver. The stored data packets represent packets waiting to be processed. In an aspect, many data packets with small sizes can represent short application MapReduce flows, which can be more urgent than data packets with larger sizes, such as long background flows.

In an implementation, the priority component 524 can be configured to apply small packet priority schemes based on a transmission mode. A transmission mode can trigger priority schemes when in a congested mode, for example. However, it is noted that the priority component 524 can apply priority schemes when not in a congested mode. Applying priority schemes can reduce latency and improve overall efficiency of a network.

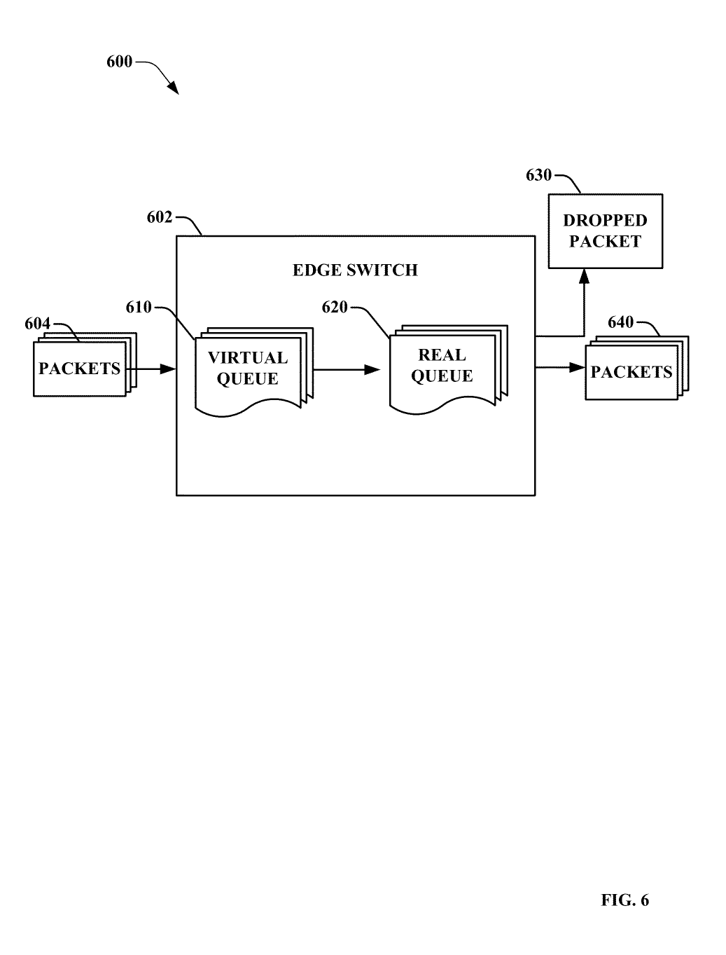

Turning now to FIG. 6, there illustrated is high level block diagram of a SP-DCUDP system 600 in operation. The system 600 includes an edge switch component 602 that can receive packets 604, transmits packets 640, and drop packets (e.g., dropped packets 630). In another aspect, edge switch component 602 can include a virtual queue 610 and a real queue 620. It is noted that the edge switch component can be part of a larger system, such as a network server, the SP-SCUDP system 500, and the like. It is noted that the virtual queue 610 and the real queue 620 can each comprise one or more respective queues.

The edge switch component 602 can receive one or more packets 604 from one or more sender devices. The packets 604 can contain information indicating a type of packet, a destination, and the like. In an aspect, the edge switch 602 component can store the packets 604 in the virtual queue 610 and/or the real queue 620. The virtual queue 610 and/or the real queue 620 can store the packets 604 until they are sent as the packets 640 and/or dropped as the dropped packets 630. However, packets need not be removed when sent and/or dropped. It is noted that the virtual queue 610 and the real queue 620 may not contain an equivalent amount of packets. As an example, the virtual queue 610 can comprise a threshold number of packets regardless of the packets being dropped or transmitted, while the real queue 620 can comprise only packets awaiting transmission.

In one aspect, the packets 604 are received by the virtual queue 610 and/or the real queue 620. In an embodiment, both the real queues 602 and the virtual queue 610 can receive the packets 604 substantially simultaneously, near simultaneously, and/or at disparate times. In some embodiments, the real queue 620 receives the packets 604 and the virtual queues 610 receive a representation of the packets 604 and/or a virtual copy of the packets 604. However, it is noted that in various embodiments, the virtual queues 620 can receive the packets 604. As referred to herein, “receiving” a packet can include receiving an actual packet, a virtual copy, and/or a representation of a packet (e.g., a count, a size, a reference number to a packet, a point to a packet, and the like), unless context suggests otherwise. Likewise, “removing” can include removing an actual packet, a virtual copy, and/or representation of a packet, unless context suggests otherwise.

The virtual queue 610 can determine a priority based of packets stored in the virtual queue 610. Determining a priority can comprise determining what packets are ECN marked, and/or dropped. In another embodiment, the virtual queue 610 can set a priority level for each received packet 604. A priority level can be a numerical, a token value, and/or the like. In one aspect, a priority level can be determined for a packet as it is received, for each packet as a packet is received, periodically, during specific transmission modes, and the like.

In various implementations, the virtual queue 610 can monitor respective sizes of packets comprised in the real queue 620. In another aspect, the virtual queue 610 can determine a packet size threshold. The packet size threshold can be determined based on packet sizes or packets in the real queue 620. In various examples, the threshold can be set as a value calculated from the packet sizes, such as a mean, medium, and/or average.

In an embodiment, the virtual queue 610 can manage congestions based on one or more queue depth thresholds and/or a packet size thresholds. In an example, a queue depth threshold can be a maximum threshold for a depth of the virtual queue 610, referred to as th_max_{vq} herein. The virtual queue 610 can receive the packets 604 and determine if the depth of the virtual queue 610 meets or exceeds th_max_{vq}. If it is determined that the depth meets or exceeds th_max_{vq} then the virtual queue 610 can trigger marking of a packet for ECN. In another aspect, the virtual queue 610 can select the packet for ECN marking based on respective packet sizes. For example, the virtual queue 610 can select a packet with a size meeting or exceeding a packet size threshold, the largest packet, a random packet, a packet based on time (e.g., oldest, newest, etc.), a combination (e.g., the newest packet over the packet size threshold), and the like. It is noted that the selected packet, may or may not be the most recently received packet (e.g. packets 604).

In various embodiments, the virtual queue 610 can further mange congestion based on a transmission mode. As an example, the virtual queue 610 can determine a transmission mode based on information in the packets 604, such as a flag indicating a transmission type (e.g., OBS bit 416). As an example, the virtual queue 610 can mark packets for ECN only when in congestion mode.

The real queue 620 can receive packets and store packets. The real queue 620 can drop and/or mark packets based on a determined priority. In various embodiments, the real queue 620 can receive a packet and trigger dropping and/or marking of packets based on a determined priority. In an example, a length of the real queue 620 can be monitored, as the length grows to a marking threshold, the real queue 620 can determine to ECN mark a packet. In another aspect, the real queue 620 can drop a packet as the real queue length reaches a dropping threshold. In various embodiments, a number of thresholds can be utilized to determine when to mark/drop a packet.

In various other embodiments, the real queue 620 can select a packet to mark/drop based on measurable metrics. A metric can be a length of a packet, a time that a packet has been in a queue, a type of packet, a sender id, and the like. As an example, a packet can be selected to be marked and/or dropped based on a packet size reaching or exceeding a threshold. In this manner, larger packets can be selected for marking and/or dropping. Thus, packets with smaller sizes can be processed before larger packets.

In an example, a real queue can determine whether to drop at least one packet from the queue and/or mark at least one packet from the queue with ECN marking. In an aspect, the real queue can determine if the length of the real queue is growing from a minimum marking threshold to a maximum marking threshold. A marking threshold can be a threshold used to determine if a packet should be ECN marked. In an example, the queue length is given by qlen, the maximum marking threshold is given by th_max, the minimum marking threshold is given by th_min, and the expect packet size, of packets in the real queue, is given by avgpktsize. If the condition:

th_max*avgpktsize≧qlen≧th_min*avgpktsize (Condition1)

holds, than the real queue 620 a packet can be select for ECN marking, and the received packet can be added to the real queue 620.

If it is determined that Condition 1 does not hold, the real queue 620 can determined if the expected length of the queue is expected to overflow past a dropping threshold based on one or more parameters. As an example, it can be determined if the following condition holds, where the dropping threshold is given by 2*th_max*avgpktsize:

avgqlen≧2*th_max*avgpktsize (Condition2)

If it is determined that Condition 2 holds, then a packet can be selected for dropping from the real queue 620, and/or the received packet can be added to the real queue 620.

If it is determined that Condition 2 does not hold, then the real queue 620 can determined if the length of the real queue 620 is equal to or greater than a real queue length threshold. In various embodiments, the real queue length threshold can be based on predetermined values, and/or parameters. As an example, the real queue length threshold can be a buffer size (B) of the real queue 620. As another example, it can be determined if the following condition holds:

qlen≧B (Condition 3)

If Condition 3 does not hold, then the real queue 620 determined not to drop or mark a packet, and the received packet can be added to real queue 620.

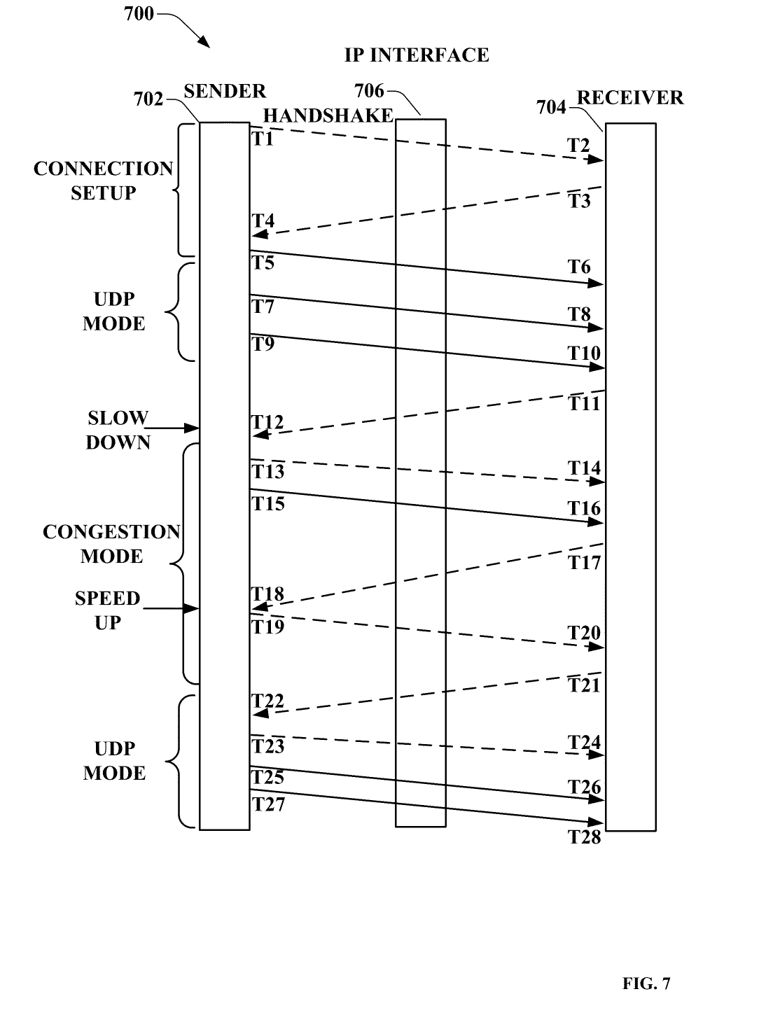

Turning now to FIG. 7, there illustrated is high level block diagram of a SP-DCUDP system 700 in operation. The SP-DCUDP system 700 is depicted with a sender component 702, a receiver component 704, and an IP interface component 706. In various implementations, additional components are utilized. However, for brevity, the SP-DCUDP system 700 is described herein without additional components for readability. In one aspect, the sender component 702, the receiver component 704, and the IP interface component 706 can comprise the SP-DCUDP system 500 (FIG. 5), the sender 310 and the receiver 340 respectively (FIG. 3), and/or one or more layers of DCUDP stack (FIGS. 1 and 2). In an aspect, the IP interface component 706 can comprise one or more queues, switches, servers, and the like.

As depicted, the sender 702 and the receiver 704 can be configured to send and receive messages, e.g. packeted data, data packets, control packets. Each packet may contain information as depicted in FIG. 4. In an embodiment, packets can be sequentially ordered to facility packet loss management. However, it is noted that packets may not be ordered, may be ordered in accordance with other conventions, and the like.

In an aspect, packets are sent from the sender 702 or the receiver 704 at a first time and received by the other at a second time. For illustrative purposes, a series of communications are depicted as sent at time Tz and received at Tz+1, where z is a number. It is noted that each time, T1-T28, can be separated by a length of time, (microseconds, milliseconds, seconds, etc.), occur simultaneous, and/or in various orders. It is noted that, each communication can comprise one or more packets, however a communication is described as a single packet sent from one component to the other, for readability. It is further noted that communications are depicted as non-overlapping and at various times for readability. Further, unless context suggests otherwise, any communication can overlap, can be in a different order, can be substituted by other communications, and/or can pass through various network components, etc. For example, a message starting at T3 can be sent from the receiver 704 through various components and be received by the sender 702 at T4. Although depicted with 18 messages sent from either the sender 702 or the receiver 704 to the other, it is noted that a different amount of messages can be sent and received in the system 700, likewise the sender 702 and the receiver 704 can send messages to and/or receive messages from various other components not shown for readability.

FIG. 7 also depicts a number of stages of the system 700. While described in the order connection setup, UDP mode, congestion mode, and UDP mode, it is noted that the stages can be in various orders. In another aspect, unless context suggests otherwise, a different amount of stages can be present, the stages can last for an indeterminate period, and the stages can comprise an indeterminate amount of messages.

In an embodiment, the system 700 can be in a connection setup stage, where the sender 702 and the receiver 704 are not connected at T1. Depending on a desired mode, the system 700 can communicate various packets between the sender 702 and the receiver 704. For example, if in a rendezvous mode, the sender 702 sends a handshake request at T1 to the receiver 704 who receives the handshake request at T2. The receiver 704 can also send a handshake request at T3 to the sender 702 that can receive at T4. In an aspect, a handshake request can comprise a control packet with a handshake type. The handshake request can comprise information to setup a connection between the sender 702 and the receiver 704, such as DCUDP version, socket type, initial sequence number, packet size, flow window size, connection type, socket IDs, cookies, IP addresses, and the like.

In another example, the system 700 can operate in a client/server mode. In client/server mode, the sender 702 can send a handshake packet at T1, e.g., data 314 sent through network 320, to the receiver 340. The sender 702 can continue sending a handshake packet (additional handshake packets not shown) until it receives a response handshake, sent from the receiver 704 as a responsive packet at T3, or when a timeout timer expires. In another aspect, the receiver 704 can create a cookie value, after receiving a handshake request at T2, based on the sender 702's address and/or a secret key, for example. The receiver 704 can sent the cookie value at T3 and the sender 702 can receive at T4. The sender 702 can send back the same cookie to the receiver 704. In another aspect, the receiver 704 can compare a received handshake packet to determine if a cookie value, packet size, maximum window size, and other data is correct based on its own values. The receiver 704 can send result values and an initial sequence number to the sender 702 by a response handshake packet. The receiver 340 is then ready for sending/receiving data. However, the receiver 704 can send back response packets as long as it receives any further handshakes from the sender 702.

In another aspect, the sender 702 can send communications (e.g., data packets), in a UDP mode, once it gets a response handshake packet from the receiver 704. As an example, the sender 702 can send data packets at T5, T7, and T9. In the UDP mode, the sender 702 can send data packets as frequently as network components can process them (e.g., sends data packets as fast as the system 700 can process), without regard for network resources or congestion control. In another aspect, the sender 704 can intermittently respond to the receiver 702's messages with keep alive packets. However, it is noted that the sender 704 can respond with ACK packets in some embodiments. In one embodiment, a responsive message can comprise quantified data indicating if received data packets were received sequentially or if a packet was lost. The responsive messages can be sent periodically, such as every 10 ms in a 10 GBit Ethernet network, for example.

In an example, a message sent from the sender 702 at T9 can comprise a data packet with an OBS bit set to “0,” indicating the sender 702 is in a UDP mode. At an IP layer, a CE code marking (ECN marking) can be set on. The CE code marking can be set depending on traffic across a network (e.g., resource usage, queue size, time delays, or other metric). In one example, the ECN marking is set based on thresholds th_max and th_min, as described herein.

In another aspect, the receiver 704 can receive a message at T10 with a CE code marking set on (e.g., set to 1). The receiver 704 can prepare a responsive message triggered by receiving a message with a CE bit set on. In one example, the responsive message sent at T11 is an ACK control packet with the OBS bit set to “1” and the ECE bit set to “1.” In one aspect, the sender 702 can receive the ACK control packet at T12. The ACK control packet can trigger one or more responsive actions from the sender 702. For example, in response to the ACK control packet received at T12, the sender 702 can enter a congestion mode. In a congestion mode, the sender 702 can control data packet communications for congestion management. In one example, the sender 702 can slow down sending of data packets, as described herein, send a control packet with an identical sequence number or next number in a sequence (e.g., ACK2 control packet) at T13, set an OBS bit for data packets to 1, determine intervals for sending data, determine thresholds, and the like.

In another aspect, the receiver 702 can receive a control packet (e.g., ACK2) from the sender 702 at T14. In an aspect, receiving an ACK2 control packet can trigger the receiver 704 to calculate recent RTT based on peers. A peer can be a set of control packets (e.g., ACK, ACK2, etc.) that represent related communications, such as communications that require a response. It is noted that peers can be sent from a single component or from multiple components (e.g., multiple senders). In an example, the receiver 704 can calculate a RTT and send ACK packets at an interval, Interval_{ACK}, based on a RTT. In an embodiment, a RTT for a most recently received packet can be denoted as rtt_{current}. The rtt_{current} can be a function of a difference between timestamps of an ACK packet and an ACK2 packet. In one example, the rtt_{current} can be represented as the equation: rtt_{current}=Timestamp_{ACK2}−Timestamp_{ACK}, where Timestamp_{ACK} is a timestamp of the most recently created ACK packet, and Timestamp_{ACK2} is a timestamp for the peer ACK2 packet of the most recently created ACK packet. It is noted that the timestamps can be stored by the receiver 704, the sender 702, other network components, or be comprised in packets (e.g., ACK packets, ACK2 packets, etc.). In one aspect, the RTT can be determined based on a current RTT, (rtt_{current},) and a number α, where α can be a predetermined value or calculated based on network characteristics. In an example, the RTT and the Interval_{ACK} can be represented as the following equation, where α is set at 0.125:

RTT=(1−α)*RTT+α*rtt_{current}

Interval_{ACK}=RTT

In an embodiment, the receiver 704 can set an initial interval for sending packets to an idle value, such as RTT_{idle}. The receiver 704 can calculate the RTT, rtt_{current}, and Interval_{ACK} upon occurrence of a triggering event (e.g., receiving an ACK2 packet). For example, the receiver 704 can send an ACK packet at T17, the sender 702 can receive the ACK packet at T18, and the sender 702 can respond with an ACK2 packet at T19.

In a congestion mode, the sender 702 can send data packets, e.g., at T15, according to congestion control management techniques. For example, the sender 702 can restrict sending of data packets based on a time threshold (e.g., one packet every RTT), based on a queue size, based on control data received in control packets (e.g., congestion levels indicated by data in ACK control packets), and/or other desired metric. A congestion level can be monitored based on a number of ACK packets sent/received over a period of time, a number of ACK packets with ECN echo bits sent over a period of time, and the like. In another aspect, the sender 702 can gradually slow down transmissions according to a rate adjustment lock, as described herein. In one aspect, the sender 702 can continue to send data packets at one interval and the receiver 704 can continue to send ACK packets at a second interval as long as the congestion mode continues. Additional communications are not shown for brevity, however, it is noted that congestion mode can continue for an indeterminate period and an indeterminate number of communications (packets) can be sent.

In an embodiment, the sender 702 can speed up sending of data packets during congestion mode based on control data received from the receiver 704, e.g., control data received at T18. For example, a data packet send from the sender 702 at T15 can have a CE bit set to “0” (e.g., off). The receiver 704 can transmit control data reflecting the CE bit set off to the sender 702 through a control packet sent at T17 to the sender 702 at T18. In another aspect, the sender 702 can transmit an ACK2 packet at T19 to the receiver 704 at T20.

The sender 704 can observe a congestion level on a network during the transmissions and determine if a congestion mode should end. In one example, the CE bit can be set to “0” (e.g., off) in the packets sent at T15 and T19. The receiver 704 can determine that the congestion mode should end based on the CE bit being off for a threshold period or threshold number of packets, RTT alterations, ECE alterations, and the like, as described herein. Determining the threshold has been reached can trigger the receiver 704 to send a control packet indicating a threshold has been reach (e.g., ACK packet with an OBS bit set off) at T21 to the sender 702. The sender 702 can respond with a control packet (e.g., ACK2 packet) at T23 comprising data indicating a mode is changed (e.g., OBS bit changed). The receiver 704 can receive a control packet indicating a mode is changed at T24. In an aspect, the control packet received at T24 can trigger the receiver 704 to stop sending ACK packets. In another aspect, the sender 702 can resume data transmissions in a UDP mode at an increased sending rate (e.g., sending packets at T25 and T27 to the receiver 704 that respectively receives the packets at T26 and T28).

In an embodiment, the receiver 704 can store data, related to communication, to facilitate congestion control management. In one aspect, the stored data can comprise information related to received/sent packets. For example, the information related to the packets can comprise a count of received ACK2 packets received, a count of packets received with CE bits set on and/or of, a value representing time delay between packet transmission, and the like. It is noted that data can be stored in various network components, such in network components comprised in an IP interface. In an aspect, the stored data can be utilized to determine if a mode should switch (e.g., switch from congestion mode to UDP mode. In embodiments, the stored data can comprise information received over a period. As an example, the receiver 704 can utilize information determined to meet a definition of recent information. In an aspect, recent information can be defined as information stored for no longer than threshold period, information stored relatively more recently than other information, and the like. It is noted that recent information can be defined respective of a period of time, number of events, and/or any other relative means of measurement that can be utilize to track changes in data.

In one embodiment, the receiver 704 sets a value K for a window size, where K is a number. A window size can be a threshold value utilized to control a length of a set, table, queue, and the like. As an example, the receiver 704 can store a set of recent RTT values (e.g., in a table, first-in-first-out (FIFO) stack, etc). The receiver 704 can store up to K RTT values. If a RTT value is received, the receiver 704 can delete the oldest RTT value, oldest respective of other RTT values, in the table and replace it with the received RTT value. In another example, the receiver 704 can store entries for a percentage of data packets received with a CE bit set on. The receiver 704 can store K entries and as a new entry is received, the oldest entry can be removed and replaced with a new entry.

In an aspect, the receiver 704 can utilized the stored data to determine congestion trends. Congestion trends can comprise determining timing trends (e.g., if delay is being altered), queue trends (e.g., as indicated by CE bits), packet sending trends, and the like. In an example, the receiver 704 stores K recent RTT values and can determine a number of RTT values that are smaller than a previously received RTT value. In an aspect, the receiver 704 can determine to trigger a switch in congestion modes based on the congestion trends. The receiver 704 can notify the sender 702 of the switch by sending an ACK control packet at T21 with an OBS bit set to “0.” In an aspect, determining congestion trends can keep the system 700 from switching transmission modes too often. As an example, the system 700 can be in a congestion mode when a queue depth falls below a threshold. However, the queue depth can rise above the threshold by the time the next data packet is sent. Accordingly, basing a switch of transmission modes on network trends and a threshold can keep a system from switch modes when a condition is near a threshold.

An exemplary algorithm is given below where the receiver 704 can monitor the congestion trends and determine to trigger a switch based on one or more conditions. It is noted that the below description is given for clarity and is only one of various embodiments. Accordingly, this disclosure is not limited to the below algorithm. The receiver 704 can checks the CE bit for every received data packet and determine whether to return ECN-echo. Therefore, for every K recent data packets received, the receiver records the portion (p_{ecn}) of the packets, with the CE bit set, as an entry in a p_{ecn} Window table of size K. When K entries are stored, the receiver 704 calculates the percentage of the p_{ecn} entries that are smaller than the previous one. The window stores the ECN trends of at most K² recent packets received. The receiver 704 can alter a sending interval (Interval_{ack}) to a fixed interval of β*RTT_{idle} if the following conditions are met, (note that θ_{ecn} is 0.5, β is 2, and θ_{RTT} is 0.2, but can be altered if desired):
where

$${P}_{pcen \leq {p}^{′} ecn} = \frac{{NumberOfP}_{ecn} \leq {P}_{ecn}^{′}}{{NumberofP}_{ecn}}$$

if (P_{pcen≦p′ecn}<θ_{ecn}, AND, P_{RTT<RTT′},<θ_{RTT}, AND, P_{pcenNewest}=0)
then

Interval_{ACK}=β*RTT_{idle}(β≧1)

If the above conditions (condition set 1) are met, then the receiver 704 can check condition set 2 to determine if congestion mode should be exited. If condition set two is met, then the receiver 704 can set the OBS bit to “0” for an ACK packet. Given that =(Number of RTT<RTT′)/(Number of RTT), then condition set 2 is given as:

P_{pcen≦p′ecn}=1, AND

P_{RTT<RTT′}=1, AND,

P_{pcenNewest}=0)

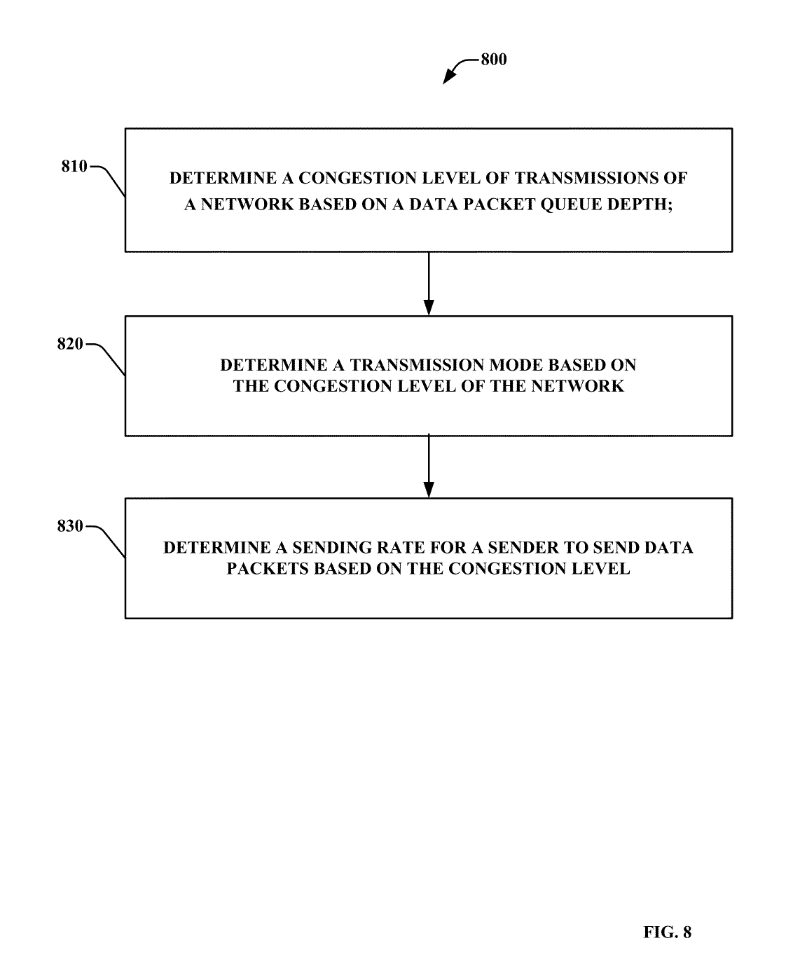

In view of the example system(s) and apparatuses described above, example method(s) that can be implemented in accordance with the disclosed subject matter are further illustrated with reference to flowcharts of FIGS. 8-15. For purposes of simplicity of explanation, example methods disclosed herein are presented and described as a series of acts; however, it is noted that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methodologies. Furthermore, not all illustrated acts may be required to implement a described example method in accordance with the subject specification. Further yet, two or more of the disclosed example methods can be implemented in combination with each other, to accomplish one or more features or advantages herein described.

Turning to FIG. 8, with reference to FIGS. 1-7, there illustrated is an exemplary method 800 to monitor congestion in a network and manage congestions through switching modes of transmission. In an aspect, method 800 can efficiently manage communications between components in a network (e.g., senders, receivers, etc.) and support reliable transmissions and fairness. It is noted that the efficiency and reliability of method 800 results from using various aspects of this disclosure.

At 810, it is assumed that variables are set in accordance with various aspects of this disclosure, and that a sender and a receiver are connected for transmission. For example, the sender 702 and the receiver 704 can have a connection setup (e.g., handshake). At 810, network conditions can be monitored. For example, a queue parameter (e.g., length) can be monitored. In an aspect, the network conditions can be instantaneous conditions. In an aspect, instantaneous conditions can comprise conditions measured at a particular time rather than averages (e.g., conditions determined over a period of time). In one aspect, an instantaneous condition can be sensitive to congestion relative to averages.

At 820, a congestion level for a network can be determined. A congestion level can be determined by a triggering event. A triggering event can be a metric (e.g., queue parameter, time period, etc.) meeting a threshold. In an asepct, a metric can also comprise a notification (e.g., a CE code point bit set). If a triggering event does not occur, a network's conditions can be monitored at 810.

If a triggering event does occur, then at 830, a transmission mode can be switched. In an aspect, a system (e.g., system 700, system 600, system 500, system 400, etc.) can switch from one transmission mode to another. For example, a receiver can send an ACK control packet with data indicating that a sender should switch transmission modes. In one example, a transmission mode can switch from a UDP mode to a congestion mode and vice versa.

In various implementations, the method 800 does not drop packet. In an aspect, as a queue size grows past a threshold (e.g., th_max), the method 700 retains packets. Retaining packets can prevent and/or reduce packet loss in a network

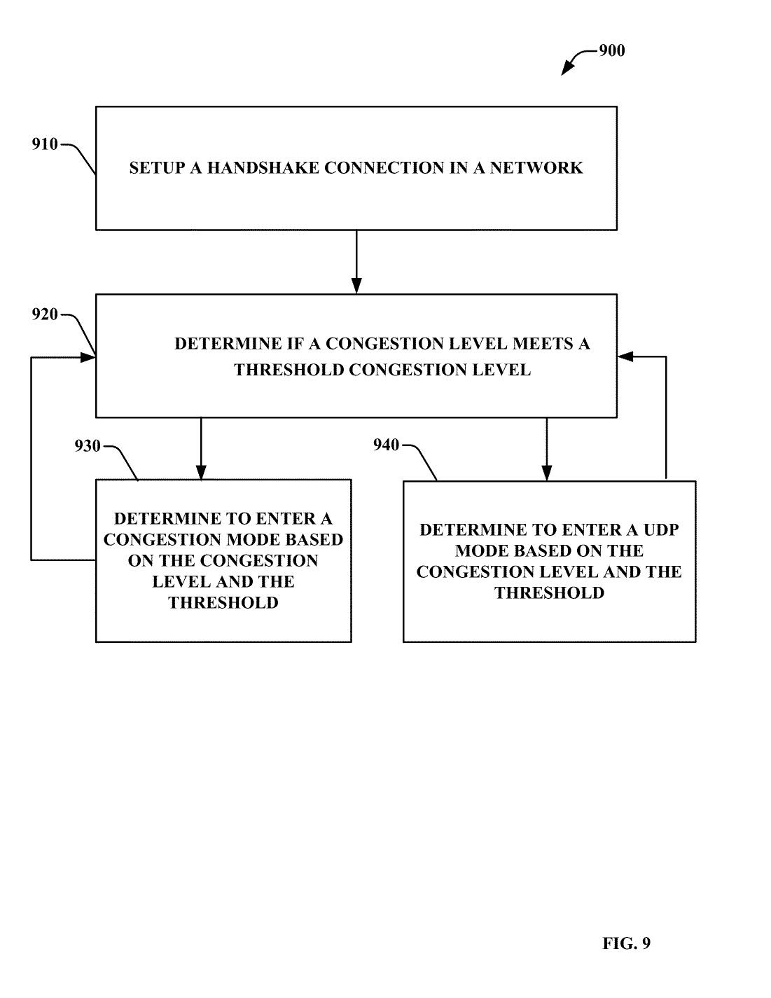

FIG. 9 presents a high level flow diagram of a method 900 for efficient network congestion management in accordance with the congestion schemes of this disclosure. At 910, network component connections are set up. In an aspect, 910 can include client/server and/or rendezvous connection transmissions (e.g., FIG. 7) between components (e.g., senders and receivers), setting of sockets, and the like.

At 920, a system can enter a UDP mode. A UDP mode can be a standard transmission mode corresponding to congestion of a network being below a threshold characterizing a congested network. It is noted that a system can enter a congestion mode as a network connection is set up.

At 930, a system in a UDP mode can switch to a congestion mode based on network characteristics, in accordance with various aspects of this disclosure. As an example, a system can switch based on availability of network resources, based on a time period, etc. In an aspect, switching to a congestion mode can comprise determining an interval to send communications, sending transmissions according to an interval, altering an RTT, and the like.

At 940, a system can exit congestion mode. In an aspect, exiting congestion mode can include determining a condition defining congestion of a network is no longer present, and/or determining as a function of network characteristics and target parameters (e.g., energy consumption, network exploration, through put, and accuracy) that a congestion level has decreased. In an example, a system can monitor communications from a receiver and determine differences between time periods of respective communications are below a threshold. At 950, a system can switch to a UDP mode. For example, in an aspect, switching to a UDP mode can comprise transmissions between components to signal a switch, altering transmission parameters (e.g., intervals, thresholds, etc.), and the like, in accordance with various aspects of this disclosure.

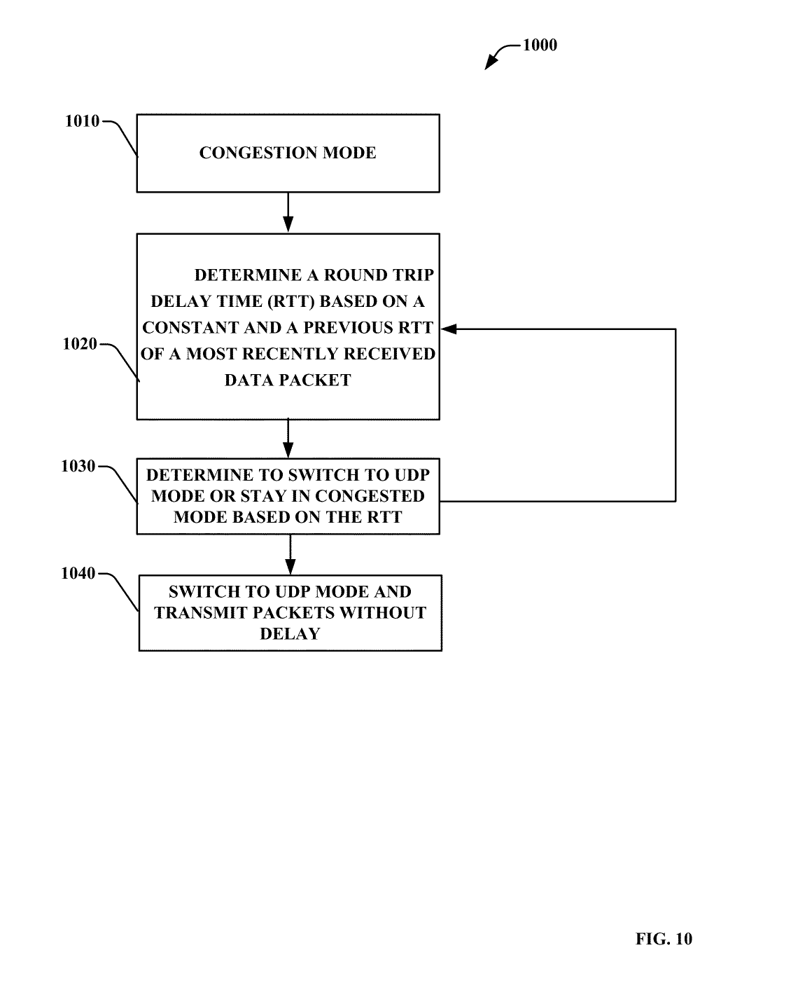

FIG. 10 presents a high level flow diagram of a method 1000 for monitoring congestions of a network while in a congestions mode in accordance with the subject network management schemes of this disclosure. At 1010 a system is assumed to be in a congestion mode. In an aspect, 1010 can include receivers acting in a congestion mode, senders acting in a congestion mode, and the like.

At 1020, a RTT and intervals can be determined. In an example, a sender can determine a RTT, time intervals and the like. At 1030, an ACK packet can be sent, for example, from a sender to a receiver. An ACK packet can include control information for system components, such as an OBS bit set to “1.” At 1040, a system component can receive an ACK packet. In another aspect, RTT trends and/or ECN trends can be determined at 1020.

At 1050, a network can be monitored. In an aspect, monitoring a network can include monitoring network characteristics, responsive packets (e.g., ACK2), CE code points, ECN trends, queue depths, and the like. In another aspect, monitoring a network can include determining what a mode for a system. For example, determining what mode to operate in can be based on the monitored network conditions and the like. If it is determined that the system should stay in a congestion mode, then the method 1000 can return to 1020 at 1060. In an aspect, the method can be iterated until a congestion mode is exited. In another aspect, if it is determined that a network is no longer experiencing congestion, then the congestion mode can be exited at 1070.

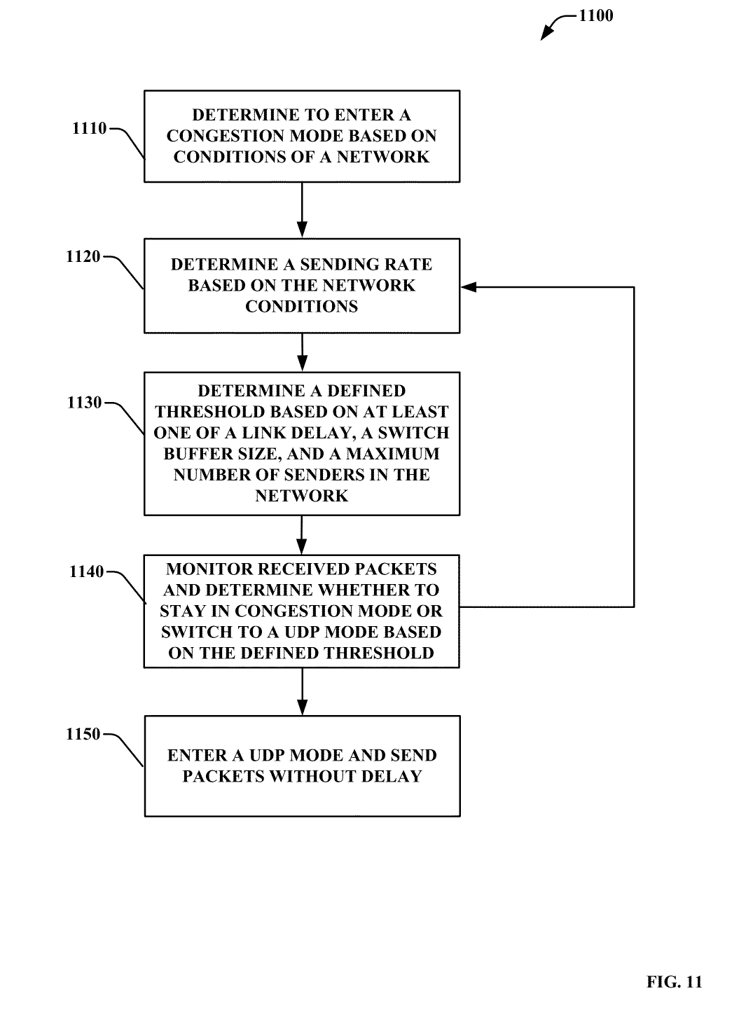

FIG. 11 presents a high level flow diagram of a method 1100 for managing congestion in a system in accordance with various aspects of this disclosure. At 1110, it is assumed that components of a system are connected through a network. Further, a server and a receiver are communicating (e.g., FIG. 7). At 1110, a system can enter a congestion mode. At 1120, a system component (e.g., the receiver 702) can determine a sending rate. In one aspect, determining the sending rate can include determining a rate to use to send data packets. In an aspect, the rate can be a modification of a current sending rate and can be a slower rate.

At 1130, an OBS bit can be set for data packets. As an example, an OBS bit for data packets can be set on (e.g., to 1) for all data packets sent while in congestion mode. As an example, the receiver 702 can set OBS bits for transmissions sent to the sender 704.

At 1140, received packets can be monitor. Monitoring received packets can include receiving packets (e.g., control packets) from a receiver and processing control information in packets. In one aspect, the determining information can include determining a mode of a system. For example, if the control information is determined to trigger staying in a congestion mode, then the method can continue at 1150 to 1140. In another example, the control information can trigger exiting congestion mode at 1160.

At 1160, a congestion mode can be exited. Exiting the congestion mode can comprise determining a new sending rate for transmissions, setting OBS bits to off for data packets, and the like.

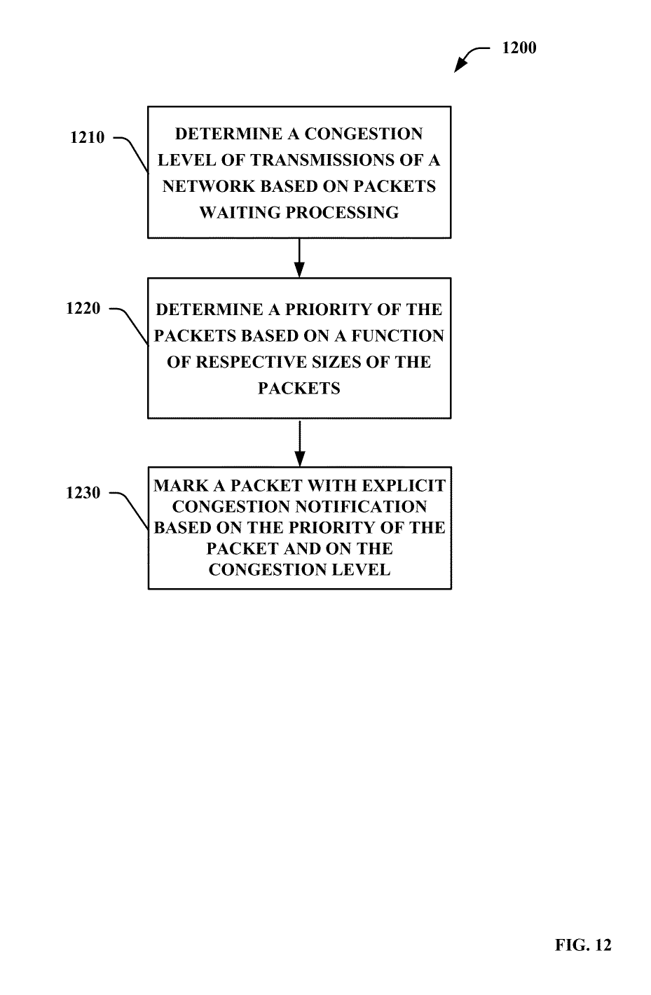

FIG. 12 presents a high level flow diagram of a method 1200 for managing congestion in a system in accordance with various aspects of this disclosure. In an aspect, the method 1200 comprises a marking and dropping method for packets in a virtual queue. In another aspect, the method 1200 can be triggered bases on a system being in a particular transmission mode (e.g., congested mode). However, it is noted that the method 1200 can be employed independent of a transmission mode.

At 1210, it is assumed that components of a system are connected through a network. Further, a server and a receiver are communicating (e.g., FIG. 7). At 1210, a congestion level of transmissions of a network can be determined based on packets waiting processing. In various aspects, a system can store packets waiting to be processing in one or more queues, such as a virtual queue and/or a real queue.

At 1220, a priority of the packets can be determined based on a function of respective sizes of the packets. In an aspect, a system can give greater priority for processing to packets with smaller sizes. In one example, a priority can be a token value stored in a data packet, and/or queue. In another example, a priority can be a determining to drop and/or mark packets with ECN based on the size of packets being over a threshold.

In one aspect, a priority is determined as packets are received. Receiving a packet can include adding the received packet to the virtual queue (e.g., enqueueing the packet), determining a virtual capacity for the virtual queue according to parameters. As an example, the virtual capacity can be based in part a packet arrival rate, a soothing rate, line rate restriction parameters, initiating parameters, and the like. In an embodiment, the capacity (C) of the virtual queue can be initiated based on an initiating parameter (β) as C′=β*C, where C′ represents the updated capacity, and β is greater than “0” and less than or equal to “1.” In another example, C′ can be updated according to the following formula, when a packet is received, where a smoothing parameter or dampening factor is represented as α, a line rate restriction parameter is represented as γ (e.g., 95%), a current time is represented as t (e.g., arrival time of the current packet), an arrival time of a previously received packet is given by s, and a size of a received packet is represented as b:

C′=max(min(C′+α*γ*C*(t−s),C)−α*b,0)

At 1230, a packet can be mark with ECN based on the priority of the packet and on the congestion level. In an aspect, a congestion level can be determined based on a virtual queue threshold size and a virtual queue depth. In one aspect, determining the virtual queue threshold size can comprise determining a virtual queue buffer size and setting the virtual queue threshold size as the virtual queue buffer size. In an aspect, virtual queue depth can be determined based on a count of entries stored in the virtual queue.

Additionally, at 1230, the virtual queue depth is compared to the virtual queue threshold size. As an example, the priority component 524 can determine if the virtual queue depth is equal to or greater than the virtual queue threshold size. If it is determined that the virtual queue depth is less than the virtual queue threshold size, the met no packet is ECN marked.

In an example, the priority can be determined based on the average size of packets in a real queue (e.g., the real queue 620). In one aspect, the determining the average size of packet in a real queue can comprise determining a mean, and/or medium size of packets in the real queue. It is noted that other methods of valuation based on the packet sizes of the packets in the real queue can be utilized, and the term “average” is used for readability.

In another example, a packet in the virtual queue is selected for ECN marking. In an aspect, a packet can be selected based on a packet size of a packet exceeding the average size of the packets in the real queue. It is noted, that any packet in the virtual queue can be selected. It is further noted that ECN marking can included setting an OBS bit of a packets to on (e.g., to “1”). In various embodiments, a virtual queue never drops packets, but rather ECN packets. However, it is noted that the virtual queue can drop packets in various other embodiments.

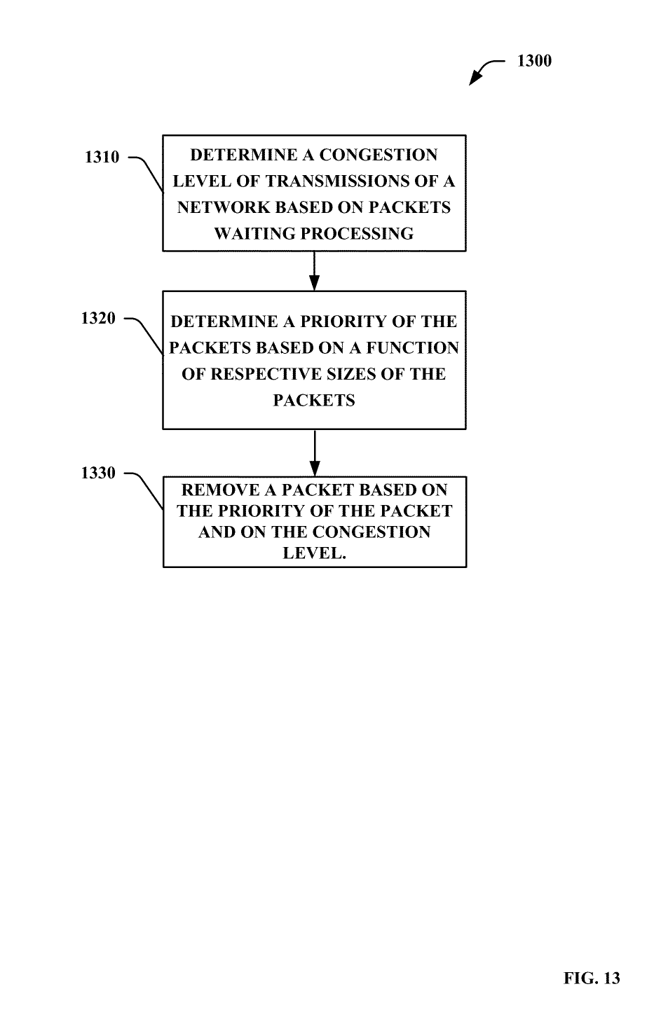

FIG. 13 presents a high level flow diagram of a method 1300 for managing congestion in a system in accordance with various aspects of this disclosure. In an aspect, the method 1300 can be utilized by a system component (e.g., the priority component 524) to drop packets in a second queue of a system (e.g., the real queue 620). At 1310, it is assumed that components of a system are connected through a network. Further, a server and a receiver are communicating (e.g., FIG. 7). At 1310, a congestion level of transmissions of a network base on packets waiting processing is determined (e.g., packets in a queue). Further, a packet can be received in the second queue (e.g., a packet sent by a receiver and received at the edge switch 602, the IP interface component 706, and the like).

In another example, determining the congestion level can include determining an expected length of the real queue is determined. In one aspect, determining the expected length of the real queue can be based on one or more parameters. The parameters can comprise a time parameters (e.g., queue growth rate, time of last received packet, time of current packet, etc.), packet lengths, and the like. In

At 1320, a priority of the packets based on a function of respective sizes of the packets waiting processing can be determined. In an aspect, a higher priority can give to packets having respective smaller sizes. In an example, a token marker can be placed to signify priority. In another aspect, a priority can be represented by selecting a packet for dropping. In another aspect, a priority can be further based on a time associated with a packet, such as the time a packet was sent and/or received. In an example, a packet that is most recently received can have a lower priority than a packet received relatively before the most recently received packet.

At 1330, a packet can be dropped based on the priority of the packet and on the congestion level. As an example, a system can determine if Condition 1, Condition 2, and/or Condition 3 holds (e.g., FIG. 6). In an example, a congestion level can be based on a dropping threshold being met. A dropping threshold can be determined based on parameter of a queue (e.g., expected queue length, actual queue length, etc.). In an aspect, a packet can be selected for dropping if the packet has a packet size larger than a packet size threshold. It is noted that the largest packet can be selected, any packet over the packet size threshold can be selected, and/or multiple packets can be selected and dropped.

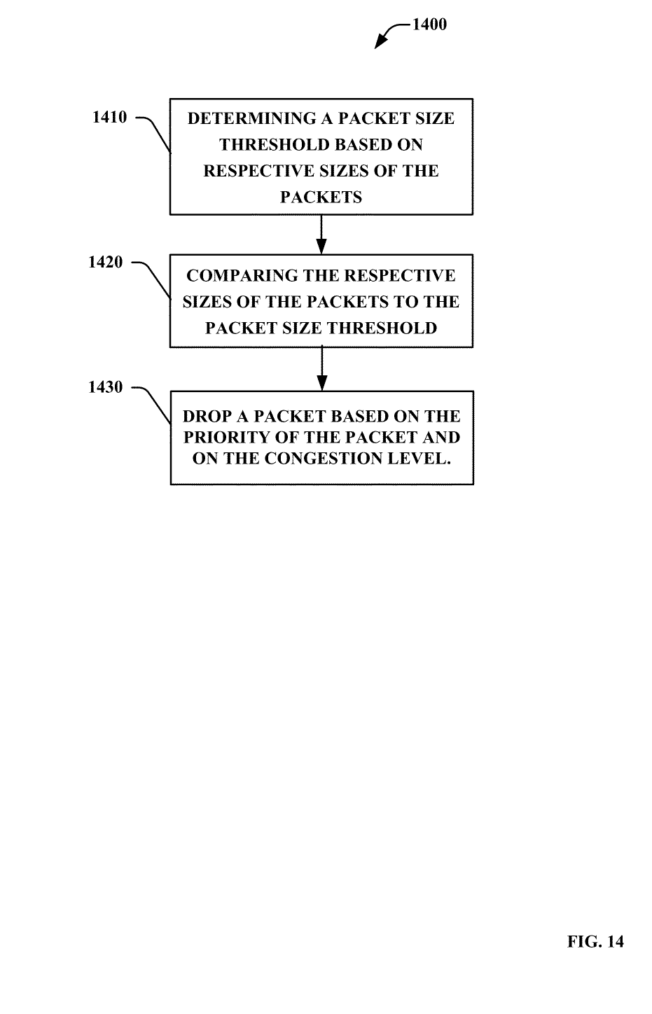

FIG. 14 presents a high level flow diagram of a method 1400 for managing congestion in a system in accordance with various aspects of this disclosure. In an aspect, the method 1400 can be utilized to enable small packet priority by managing dropping selections in a real queue and/or virtual queue. At 1410, it is assumed that components of a system are connected through a network. Further, a server and a receiver are communicating via an IP interface (e.g., FIG. 7). At 1410, a packet size threshold is determined based on respective packet sizes (e.g., average, medium, mean, or other metric). Method 1400 is referred to herein as relating to a real queue, for brevity, however, the method 1400 can utilize a first queue, a second queue, and the like.

At 1420, respective sizes of packets are compared to the packet size threshold. In an aspect, a priority is based on the compared packet sizes to the packet size threshold. It is noted that a comparison can be stored in memory, for example. In an aspect, comparing the respective sizes of the packets to the packet size threshold can include determining if a size of a received packet is greater than or equal to the packet size threshold.

At 1430, a packet can be dropped based on the priority of the packet and the congestion level. In an aspect, the priority can be based on the comparison of the respective sizes of packets and the packet size threshold. In one aspect, if it is determined that the size of a received packet is less than the average packet size, then the received packet can be dropped.

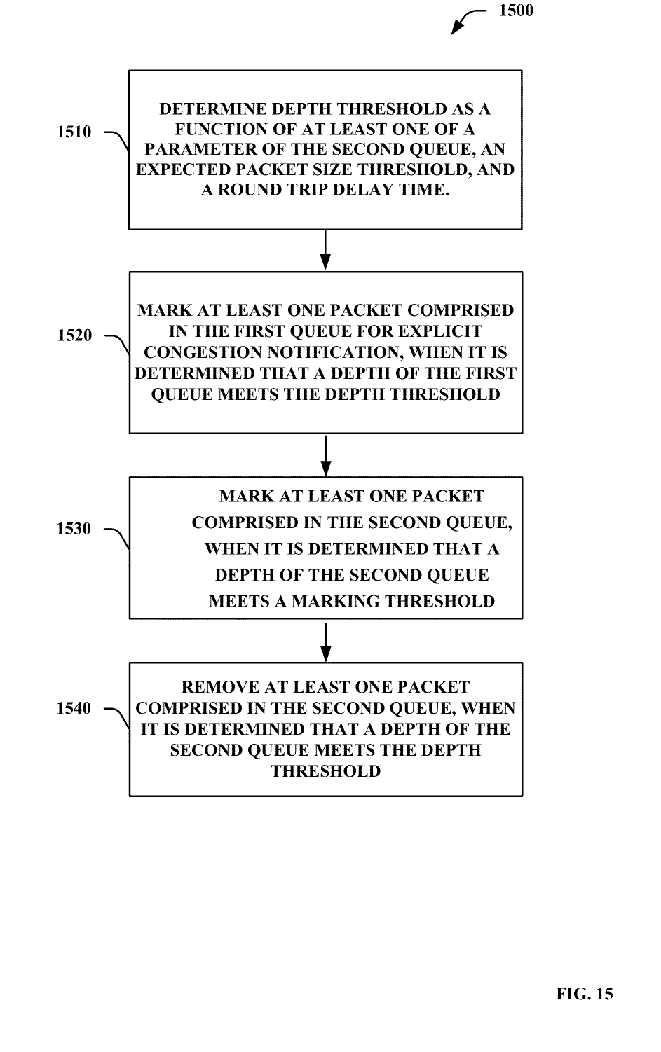

FIG. 15 presents a high level flow diagram of a method 1500 for managing congestion in a system in accordance with various aspects of this disclosure. In an aspect, the method 1500 can be utilized to enable small packet priority by managing dropping and/or marking of packets in virtual queue and/or real queue (e.g., first queue and/or second queue). At 1510, it is assumed that components of a system are connected through a network and a packet is received at an IP interface. Further, a server and a receiver are communicating via an IP interface (e.g., FIG. 7). At 1510, a depth threshold is determined as a function of at least one of a parameter of a second queue, an expected packet size threshold, and a RTT. In an aspect, one or more depth thresholds can be determined.

At 1520, at least one packet can be marked in a first queue (e.g., a virtual queue) for ECN when it is determined that a depth of the first queue meets the depth threshold. In an aspect, the depth threshold can be a length of the first queue, such as a virtual length. It is noted, that a packet may not be marked if the queue depth threshold is not met.

At 1530, at least one packet from the second queue can be marked when it is determined that a depth of the second queue meets a marking threshold. In an aspect, the marking threshold can be determined, such as in Condition 1.

At 1540, at least one packet can be removed from the second queue when it is determined that a depth of the second queue meets the depth threshold. In an aspect, the depth threshold can be determined such as in Condition 2, and/or 3.

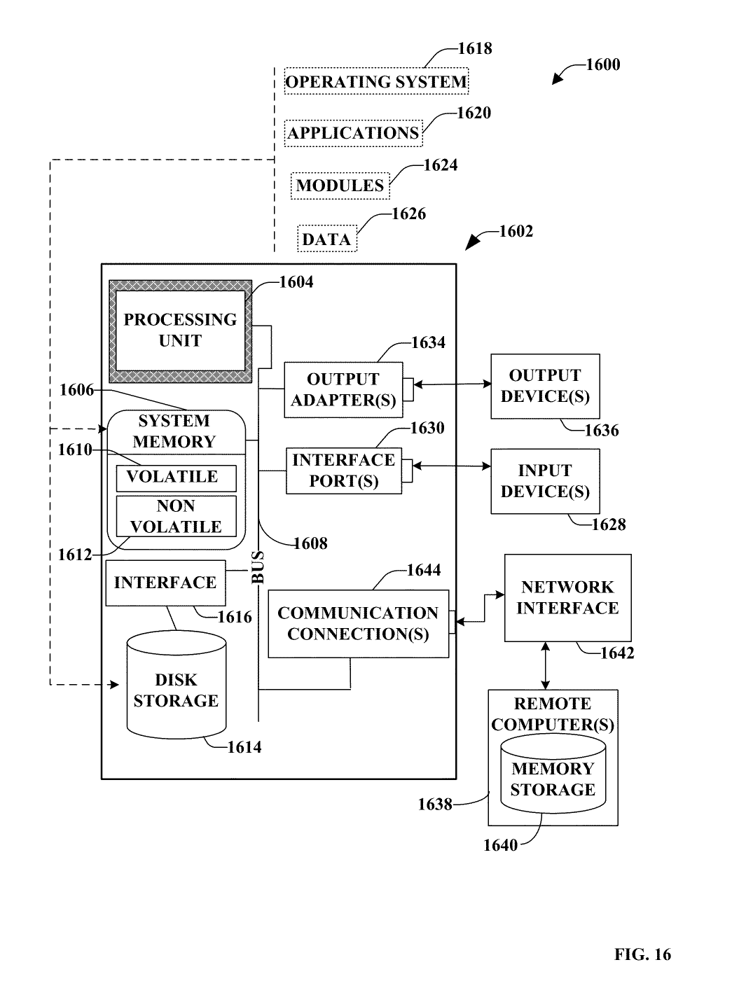

Referring now to FIG. 16, there is illustrated a block diagram of a computer operable to provide networking and communication capabilities between a wired or wireless communication network and a server and/or communication device. In order to provide additional context for various aspects thereof, FIG. 16 and the following discussion are intended to provide a brief, general description of a suitable computing environment 1600 in which the various aspects of the various embodiments can be implemented. While the description above is in the general context of computer-executable instructions that can run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, handheld computing devices, microprocessor-based or programmable consumer electronics, and the like, each of which can be operatively coupled to one or more associated devices.

The illustrated aspects of the various embodiments can also be practiced in distributed computing environments where certain tasks are performed by remote processing devices that are linked through a communications network. In a distributed computing environment, program modules can be located in both local and remote memory storage devices.

With reference to FIG. 16, a suitable environment 1600 for implementing various aspects of the claimed subject matter includes a computer 1602. The computer 1602 includes a processing unit 1604, a system memory 1606, a codec 1605, and a system bus 1608. The system bus 1608 couples system components including, but not limited to, the system memory 1606 to the processing unit 1604. The processing unit 1604 can be any of various available processors. Dual microprocessors and other multiprocessor architectures also can be employed as the processing unit 1604.

The system bus 1608 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1606 can include volatile memory 1610 and non-volatile memory 1612. The basic input/output system (BIOS), containing the basic routines to transfer information between elements within the computer 1602, such as during start-up, is stored in non-volatile memory 1612. By way of illustration, and not limitation, non-volatile memory 1612 can include read only memory (ROM), programmable ROM (PROM), electrically programmable ROM (EPROM), electrically erasable programmable ROM (EEPROM), or flash memory. Volatile memory 1610 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDRx SDRAM), and enhanced SDRAM (ESDRAM). Volatile memory 1610 can implement various aspects of this disclosure, including memory systems containing MASCH components.

Computer 1602 may also include removable/non-removable, volatile/non-volatile computer storage media. FIG. 16 illustrates, for example, a disk storage 1614. Disk storage 1614 includes, but is not limited to, devices like a magnetic disk drive, solid state disk (SSD) floppy disk drive, tape drive, Zip drive, LS-100 drive, flash memory card, or memory stick. In addition, disk storage 1614 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1614 to the system bus 1608, a removable or non-removable interface is typically used, such as interface 1616.

It is to be appreciated that FIG. 16 describes software, software in execution, hardware, and/or software in combination with hardware that acts as an intermediary between users and the basic computer resources described in the suitable operating environment 1600. Such software includes an operating system 1618. Operating system 1618, which can be stored on disk storage 1614, acts to control and allocate resources of the computer system 1602. Applications 1620 take advantage of the management of resources by operating system 1618 through program modules 1624, and program data 1626, such as the boot/shutdown transaction table and the like, stored either in system memory 1606 or on disk storage 1614. It is to be appreciated that the claimed subject matter can be implemented with various operating systems or combinations of operating systems. For example, applications 1620 and program data 1626 can include software implementing aspects of this disclosure.

A user enters commands or information into the computer 1602 through input device(s) 1628. Input devices 1628 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1604 through the system bus 1608 via interface port(s) 1630. Interface port(s) 1630 include, for example, a serial port, a parallel port, a game port, and a universal serial bus (USB). Output device(s) 1636 use some of the same type of ports as input device(s) 1628. Thus, for example, a USB port may be used to provide input to computer 1602 and to output information from computer 1602 to an output device 1636. Output adapter 1634 is provided to illustrate that there are some output devices 1636 like monitors, speakers, and printers, among other output devices 1636, which require special adapters. The output adapters 1634 include, by way of illustration and not limitation, video and sound cards that provide a means of connection between the output device 1636 and the system bus 1608. It should be noted that other devices and/or systems of devices provide both input and output capabilities such as remote computer(s) 1638.

Computer 1602 can operate in a networked environment using logical connections to one or more remote computers, such as remote computer(s) 1638. The remote computer(s) 1638 can be a personal computer, a server, a router, a network PC, a workstation, a microprocessor based appliance, a peer device, a smart phone, a tablet, or other network node, and typically includes many of the elements described relative to computer 1602. For purposes of brevity, only a memory storage device 1640 is illustrated with remote computer(s) 1638. Remote computer(s) 1638 is logically connected to computer 1602 through a network interface 1642 and then connected via communication connection(s) 1644. Network interface 1642 encompasses wire and/or wireless communication networks such as local-area networks (LAN), wide-area networks (WAN), and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1644 refers to the hardware/software employed to connect the network interface 1642 to the bus 1608. While communication connection 1644 is shown for illustrative clarity inside computer 1602, it can also be external to computer 1602. The hardware/software necessary for connection to the network interface 1642 includes, for exemplary purposes only, internal and external technologies such as, modems including regular telephone grade modems, cable modems and DSL modems, ISDN adapters, wired and wireless Ethernet cards, hubs, and routers. It is to be understood that aspects described herein may be implemented by hardware, software, firmware, or any combination thereof. When implemented in software, functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor may be a microprocessor, but, in the alternative, processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. Additionally, at least one processor may comprise one or more modules operable to perform one or more of the s and/or actions described herein.

For a software implementation, techniques described herein may be implemented with modules (e.g., procedures, functions, and so on) that perform functions described herein. Software codes may be stored in memory units and executed by processors. Memory unit may be implemented within processor or external to processor, in which case memory unit can be communicatively coupled to processor through various means as is known in the art. Further, at least one processor may include one or more modules operable to perform functions described herein.

Techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2300, etc. UTRA includes Wideband-CDMA (W-CDMA) and other variants of CDMA. Further, CDMA2300 covers IS-2300, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.23, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA2300 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction, and/or data. Additionally, a computer program product may include a computer readable medium having one or more instructions or codes operable to cause a computer to perform functions described herein.

Further, the actions of a method or algorithm described in connection with aspects disclosed herein may be embodied directly in hardware, in a software module executed by a processor, or a combination thereof. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to processor, such that processor can read information from, and write information to, storage medium. In the alternative, storage medium may be integral to processor. Further, in some aspects, processor and storage medium may reside in an ASIC. Additionally, ASIC may reside in a user terminal. In the alternative, processor and storage medium may reside as discrete components in a user terminal. Additionally, in some aspects, the steps and/or actions of a method or algorithm may reside as one or any combination or set of codes and/or instructions on a machine-readable medium and/or computer readable medium, which may be incorporated into a computer program product.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating there from. Therefore, the disclosed subject matter should not be limited to any single embodiment described herein, but rather should be construed in breadth and scope in accordance with the appended claims below.

What is claimed is:

1. A system comprising:
a processor that executes or facilitates execution of computer executable components stored in a computer readable storage medium, the computer executable components comprising:
a network monitor component configured to determine a network congestion level of a network based on a function of a set of transmissions awaiting processing;
a congestion control component configured to:
determine a transmission mode based on the network congestion level and a function of a network congestion threshold; and
based on the transmission mode, determine a sending rate at which other transmissions are to be received for addition to the set of transmissions; and
a priority component configured to determine a priority of packets of the set of transmissions based on sizes of the packets.

2. The system of claim 1, wherein the network monitor component is configured to determine the network congestion level based on a parameter that is modified based on whether a queue depth has been determined to satisfy another function of a defined threshold.

3. The system of claim 1, wherein the network monitor component is further configured to monitor the set of the transmissions including data indicating at least one of respective times of the set of the transmissions, respective parameters based on the network congestion level, or respective types of the set of the transmissions.

4. The system of claim 3, wherein the network monitor component is further configured to determine a trend of the network based on an output of the set of the transmissions being monitored.

5. The system of claim 4, wherein, to determine the trend, the network monitor component is further configured to store K round trip delay time (RTT) values and determine a number of the K RTT values that are smaller than a previously received RTT value, wherein K is an integer.

6. The system of claim 2, wherein the network monitor component is further configured to determine the defined threshold based on at least one of a link delay, a switch buffer size, or a maximum number of senders in the network.

7. The system of claim 1, wherein the transmissions are constrained by another function of a minimum rate and a maximum rate represented by the sending rate.

8. The system of claim 1, further comprising an edge switch component configured to selectively manage queues comprising entries related to the packets.

9. The system of claim 1, wherein the priority component is further configured to:
mark at least one packet of the packets for explicit congestion notification or remove the at least one packet from the set based on at least one of the congestion level or the at least one packet being determined to have a low priority.

10. The system of claim 1, wherein the priority component is further configured to:
manage a set of queues, comprising a first queue and a second queue, configured to store the packets.

11. The system of claim 10, wherein the priority component is further configured to:
select a packet of the first queue to mark for explicit congestion notification, in response to a determination that a depth of the first queue satisfies a first queue depth threshold.

12. The system of claim 11, wherein priority component is further configured to select the packet to be marked for explicit congestion notification based on a size of the packet being determined to satisfy a packet size threshold.

13. The system of claim 1, wherein the priority component is further configured to determine a packet size threshold based on the sizes of the packets.

14. The system of claim 10, wherein the first queue comprises a simulated queue that has an adaptive capacity.

15. The system of claim 10, wherein the priority component is further configured to select a packet stored in the second queue to mark for explicit congestion notification, in response to a determination that a depth of the second queue meets a marking threshold.

16. The system of claim 15, wherein the priority component is further configured to select the packet based on a size of the packet being determined to satisfy a packet size threshold.

17. The system of claim 14, wherein the priority component is further configured to drop a packet of the packets in response to a determination that an expected queue length satisfies a dropping threshold.

18. The system of claim 17, wherein the priority component is further configured to determine the dropping threshold based on a parameter of the second queue.

19. The system of claim 17, wherein the priority component is further configured to select the packet from the second queue based on a size of the packet being determined to satisfy a packet size threshold.

20. A method, comprising:
determining, by a system comprising a processor, a congestion level of a set of transmissions of a network based on a set of packets of the set of transmissions awaiting processing;
determining a transmission mode based on the congestion level of the network;
determining a sending rate at which other transmissions are to be received based on the congestion level, wherein the other transmissions are to be included in the set of transmissions; and
determining priorities of respective packets of the set of packets, based on a function of respective sizes of the respective packets.

21. The method of claim 20 further comprising switching the transmission mode in response to the congestion level being determined to satisfy a function of a threshold.

22. The method of claim 20 further comprising altering a flag representing the transmission mode, the flag being represented in a packet of the set of packets based on the transmission mode.

23. The method of claim 21, wherein the transmission mode comprises:
determining the transmission mode is a non-congested mode in response to determining that the congestion level satisfies a function of a threshold; and
determining the transmission mode is a congested mode in response to determining that the congestion level does not satisfy the function of the threshold.

24. The method of claim 21, further comprising:
sending the transmissions at a rate without delay in response to determining the transmission mode is the non-congested mode; and
sending the transmissions at a determined rate slower than the rate in response to determining the transmission mode is the congested mode.

25. The method of claim 20, wherein switching the transmission mode is based in part on determining a network trend.

26. The method of claim 25, wherein, in response to determining the transmission mode is the congested mode, the determining the network trend comprises determining respective round trip delay time values for the respective packets of the set of packets.

27. The method of claim 25, wherein, in response to determining the transmission mode is the congested mode, the determining the network trend comprises monitoring the set of packets and counting a number of packets of the set of packets with a congestion experience flag determined to have been set.

28. The method of claim 20, further comprising removing a packet of the set of packets based on a priority of the packet and the congestion level.

29. The method of claim 20, further comprising marking a packet of the set of packets with an explicit congestion notification based on a priority of the packet and on the congestion level.

30. The method of claim 20, wherein determining the priorities of the respective packets further comprises:
determining a packet size threshold based on the respective sizes; and
comparing the respective sizes to the packet size threshold.

31. The method of claim 20, further comprising managing a set of queues comprising a first queue and a second queue, wherein the first queue and the second queue are configured to store the set of packets.

32. The method of claim 31, further comprising marking at least one packet stored in the first queue for explicit congestion notification, in response to a determination that a depth of the first queue satisfies a depth threshold.

33. The method of claim 31, further comprising removing at least one packet from the second queue, in response to a determination that a depth of the second queue satisfies a depth threshold.

34. The method of claim 31, further comprising determining the depth threshold as a function of at least one of a parameter of the second queue, an expected packet size threshold, or a round trip delay time.

35. A system, comprising:
means for determining a congestion level as a function of a network parameter, wherein the network parameter represents a level of congestion associated with network devices of a network at a point in time;
means for determining a transmission mode as a function of the network parameter;
means for adjusting a sending rate of received transmissions as a function of the transmission mode; and
means for prioritizing a set of packets awaiting processing, wherein the prioritizing determines respective processing priorities of the set of packets.

36. The system of claim 35, wherein the means for prioritizing the set of packets sets the respective processing priorities based on respective sizes of the set of packets.

37. The system of claim 36, wherein packets of the set of packets with smaller sizes, relative to other packets of the set of packets, are given a higher priority.

38. The system of claim 36, wherein packets of the set of packets that are assigned low priorities are removed or flagged for congestion management.

39. A computer-readable storage medium comprising computer-executable instructions that, in response to execution, cause a device including a processor to perform operations, comprising:
determining a congestion level in a network at a time;
determining a transmission mode based on the congestion level;
determining a sending rate based on a network characteristic and the transmission mode;
configuring sending of transmissions to be based on the sending rate; and
determining respective priorities of a set of packets, wherein the respective priorities are based on respective packet sizes of the set of packets.

40. The computer-readable storage medium of claim 39, wherein the operations further comprise setting a congestion experience flag for a packet of the set of packets based on the respective priorities and the set of packets being determined to exceed a threshold characteristic.

41. The computer-readable storage medium of claim 39, wherein the operations further comprise removing a packet from the set of packets, based on the respective priorities and a characteristic of the set of packets being determined to exceed a threshold characteristic.

42. The computer-readable storage medium of claim 39, wherein the operations further comprise managing a first queue, having an adaptive capacity, to determine a parameter of a second queue.
